(19) United States
(12) Patent Application Publication
(10) Pub. No.: US 2024/0394585 A1
(43) Pub. Date: Nov. 28, 2024

(54) Modifiable Quantum Error Correction Code for Logical Qubits

(71) Applicant: Rigetti & Co, LLC, Berkeley, CA (US)

(72) Inventor: Matthew J. Reagor, San Rafael, CA (US)

(73) Assignee: Rigetti & Co, LLC, Berkeley, CA (US)

(21) Appl. No.: 18/763,043

(22) Filed: Jul. 3, 2024

Related U.S. Application Data
(63) Continuation of application No. PCT/US2023/060661, filed on Jan. 13, 2023.
(60) Provisional application No. 63/299,299, filed on Jan. 13, 2022.

(51) Int. Cl. G06N 10/70; G06N 10/40

(52) U.S. Cl. CPC G06N 10/70; G06N 10/40

(57) ABSTRACT

In a general aspect, a method of modifying a quantum error correction code for logical qubits is described. In some implementations, a method includes, by operation of classical computing systems, determining target values of logical errors associated with applying operations on logical qubits; by operation of the quantum computing system, measuring observed values of the logical errors associated with applying the operations on the logical qubits; and by operation of the classical computing systems, updating the quantum error correction code based on the target values and the observed values of the logical errors. Updating the quantum error correction code includes modifying a quantum error correction pattern for one or more of the logical qubits. The method further includes, by operation of the quantum computing system, applying the quantum error correction code using the modified quantum error correction pattern while executing a quantum computing routine.

### CROSS-REFERENCE TO RELATED APPLICATIONS

This application claims priority to U.S. Provisional Patent Application No. 63/299,299, filed Jan. 13, 2022, entitled “Optimizing Compilation of Error Corrected Logical Qubits.” The above-referenced priority document is incorporated herein by reference in its entirety.

### TECHNICAL FIELD

The following description relates to a modifiable quantum error correction code for logical qubits defined by superconducting qubit devices in a quantum processing unit.

### BACKGROUND

Quantum computers can perform computational tasks by storing and processing information within quantum states of quantum systems. For example, qubits (i.e., quantum bits) can be stored in, and represented by, an effective two-level sub-manifold of a quantum coherent physical system. A variety of physical systems have been proposed for quantum computing applications. Examples include superconducting circuits, trapped ions, spin systems, and others.

### BRIEF DESCRIPTION OF THE DRAWINGS

FIG. 1 is a block diagram of an example computing environment.

FIG. 2 is a schematic diagram showing aspects of an example quantum computing system.

FIG. 3A is an example of a physical qubit layout for supporting in-situ optimized logical qubit definitions.

FIG. 3B is an example of a physical qubit layout for supporting in-situ optimized logical qubit definitions.

FIG. 4A is a schematic diagram showing aspects of an example quantum error correction pattern of a quantum error correction code.

FIG. 4B is a schematic diagram showing aspects of an example quantum error correction pattern of a quantum error correction code.

FIG. 4C is a schematic diagram showing aspects of an example quantum error correction pattern of a quantum error correction code.

FIG. 4D is a schematic diagram showing aspects of an example quantum error correction pattern of a quantum error correction code.

FIG. 5 is a flow diagram showing aspects of an example process for updating a quantum error correction code.

### DETAILED DESCRIPTION

In some aspects of what is described here, a quantum error correction code can be used to protect quantum information from errors due to decoherence and other quantum noise. A quantum error correction code includes redundant operations of one or more logical qubits defined by blocks of physical qubit devices in a quantum computing system. In some implementations, a quantum error correction code can be updated or modified prior to or during an execution of a quantum computing program at runtime. In some instances, the quantum error correction code can be updated or modified according to one or more criteria. For example, the quantum error correction code can be updated based on target values and observed values of logical errors associated with logical qubits and operations applied on the logical qubit. In some instances, the quantum error correction code can be updated based on observed values of algorithmic errors associated with applying the quantum computing program.

In some implementations, updating a quantum error correction code is enabled by high-connectivity superconducting qubit devices in a superconducting quantum processing unit. For example, a stabilizer check qubit device in a planar code patch of the quantum error correction code can be operably connected to other stabilizer check qubit devices from neighboring planar code patches. The methods and systems presented here can enable a stabilizer measurement with a tunable relative weight. Coupling elements between stabilizer check qubit devices in different planar code patches can be selectively activated or deactivated to allow a dynamic update to the quantum error correction code.

In some implementations, the systems and techniques described here can provide technical advantages and improvements. The methods and systems presented here allow in-situ optimization of the quantum error correction code during runtime of a quantum computing program. The methods and techniques presented here may enable a superconducting quantum computing system for performing efficient stabilizer measurements with a tunable relative weight in a quantum error-correcting procedure. The methods and techniques presented can have error correction advantages due to a higher threshold, a lower logical error, and reduced physical overhead. In some cases, a combination of these and potentially other advantages and improvements may be obtained.

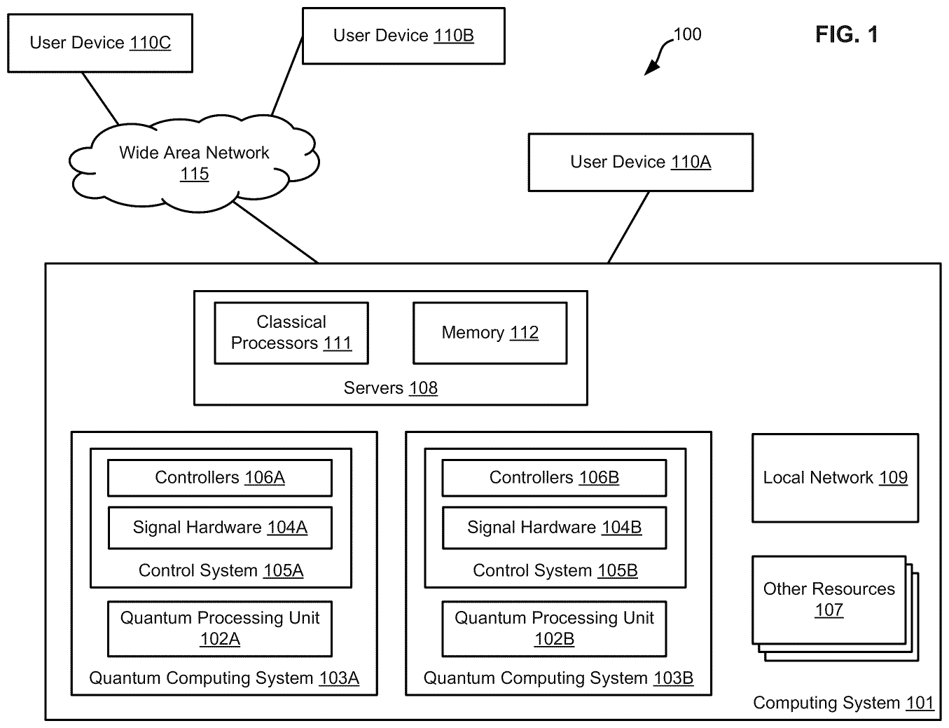

FIG. 1 is a block diagram of an example computing environment 100. The example computing environment 100 shown in FIG. 1 includes a computing system 101 and user devices 110A, 110B, 110C. A computing environment may include additional or different features, and the components of a computing environment may operate as described with respect to FIG. 1 or in another manner.

The example computing system 101 includes classical and quantum computing resources and exposes their functionality to the user devices 110A, 110B, 110C (referred to collectively as “user devices 110”). The computing system 101 shown in FIG. 1 includes one or more servers 108, quantum computing systems 103A, 103B, a local network 109, and other resources 107. The computing system 101 may also include one or more user devices (e.g., the user device 110A) as well as other features and components. A computing system may include additional or different features, and the components of a computing system may operate as described with respect to FIG. 1 or in another manner.

The example computing system 101 can provide services to the user devices 110, for example, as a cloud-based or remote-accessed computer system, as a distributed computing resource, as a supercomputer or another type of high-performance computing resource, or in another manner. The computing system 101 or the user devices 110 may also have access to one or more other quantum computing systems (e.g., quantum computing resources that are accessible through the wide area network 115, the local network 109, or otherwise).

The user devices 110 shown in FIG. 1 may include one or more classical processors, memory, user interfaces, communication interfaces, and other components. For instance, the user devices 110 may be implemented as laptop computers, desktop computers, smartphones, tablets, or other types of computer devices. In the example shown in FIG. 1, to access computing resources of the computing system 101, the user devices 110 send information (e.g., programs, instructions, commands, requests, input data, etc.) to the servers 108; and in response, the user devices 110 receive information (e.g., application data, output data, prompts, alerts, notifications, results, etc.) from the servers 108. The user devices 110 may access services of the computing system 101 in another manner, and the computing system 101 may expose computing resources in another manner.

In the example shown in FIG. 1, the local user device 110A operates in a local environment with the servers 108 and other elements of the computing system 101. For instance, the user device 110A may be co-located with (e.g., located within 0.5 to 1 km of) the servers 108 and possibly other elements of the computing system 101. As shown in FIG. 1, the user device 110A communicates with the servers 108 through a local data connection.

The local data connection in FIG. 1 is provided by the local network 109. For example, some or all of the servers 108, the user device 110A, the quantum computing systems 103A, 103B, and the other resources 107 may communicate with each other through the local network 109. In some implementations, the local network 109 operates as a communication channel that provides one or more low-latency communication pathways from the server 108 to the quantum computing systems 103A, 103B (or to one or more of the elements of the quantum computing systems 103A, 103B). The local network 109 can be implemented, for instance, as a wired or wireless Local Area Network, an Ethernet connection, or another type of wired or wireless connection. The local network 109 may include one or more wired or wireless routers, wireless access points (WAPs), wireless mesh nodes, switches, high-speed cables, or a combination of these and other types of local network hardware elements. In some cases, the local network 109 includes a software-defined network that provides communication among virtual resources, for example, among an array of virtual machines operating on the server 108 and possibly elsewhere.

In the example shown in FIG. 1, the remote user devices 110B, 110C operate remotely from the servers 108 and other elements of the computing system 101. For instance, the user devices 110B, 110C may be located at a remote distance (e.g., more than 1 km, 10 km, 100 km, 1,000 km, 10,000 km, or farther) from the servers 108 and possibly other elements of the computing system 101. As shown in FIG. 1, each of the user devices 110B, 110C communicates with the servers 108 through a remote data connection.

The remote data connection in FIG. 1 is provided by a wide area network 115, which may include, for example, the Internet or another type of wide area communication network. In some cases, remote user devices use another type of remote data connection (e.g., satellite-based connections, a cellular network, a virtual private network, etc.) to access the servers 108. The wide area network 115 may include one or more internet servers, firewalls, service hubs, base stations, or a combination of these and other types of remote networking elements. Generally, the computing environment 100 can be accessible to any number of remote user devices.

The example servers 108 shown in FIG. 1 can manage interaction with the user devices 110 and utilization of the quantum and classical computing resources in the computing system 101. For example, based on information from the user devices 110, the servers 108 may delegate computational tasks to the quantum computing systems 103A, 103B and the other resources 107; the servers 108 can then send information to the user devices 110 based on output data from the computational tasks performed by the quantum computing systems 103A, 103B, and the other resources 107.

As shown in FIG. 1, the servers 108 are classical computing systems that include classical processors 111 and memory 112. The servers 108 may also include one or more communication interfaces that allow the servers to communicate via the local network 109, the wide area network 115, and possibly other channels. In some implementations, the servers 108 may include a host server, an application server, a virtual server, or a combination of these and other types of servers. The servers 108 may include additional or different features and may operate as described with respect to FIG. 1 or in another manner.

The classical processors 111 can include various kinds of apparatus, devices, and machines for processing data, including, by way of example, a microprocessor, a central processing unit (CPU), a graphics processing unit (GPU), an FPGA (field programmable gate array), an ASIC (application specific integrated circuit), or combinations of these. The memory 112 can include, for example, a random-access memory (RAM), a storage device (e.g., a writable read-only memory (ROM) or others), a hard disk, or another type of storage medium. The memory 112 can include various forms of volatile or non-volatile memory, media, and memory devices, etc.

Each of the example quantum computing systems 103A, 103B operates as a quantum computing resource in the computing system 101. The other resources 107 may include additional quantum computing resources (e.g., quantum computing systems, quantum simulators, or both) as well as classical (non-quantum) computing resources such as, for example, digital microprocessors, specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), etc., or combinations of these and other types of computing modules.

In some implementations, the servers 108 generate programs, identify appropriate computing resources (e.g., a QPU or QVM) in the computing system 101 to execute the programs, and send the programs to the identified resources for execution. For example, the servers 108 may send programs to the quantum computing system 103A, the quantum computing system 103B, or any of the other resources 107. The programs may include classical computing programs, quantum computing programs, hybrid classical/quantum computing programs, and may include any type of function, code, data, instruction set, etc.

In some instances, programs can be formatted as source code that can be rendered in human-readable form (e.g., as text) and can be compiled, for example, by a compiler running on the servers 108, on the quantum computing systems 103, or elsewhere. In some instances, programs can be formatted as compiled code, such as, for example, binary code (e.g., machine-level instructions) that can be executed directly by a computing resource. Each program may include instructions corresponding to computational tasks that, when performed by an appropriate computing resource, generate output data based on input data. For example, a program can include instructions formatted for a quantum computer system, a simulator, a digital microprocessor, co-processor or other classical data processing apparatus, or another type of computing resource.

In some cases, a program may be expressed in a hardware-independent format. For example, quantum machine instructions may be provided in a quantum instruction language such as Quil, described in the publication “A Practical Quantum Instruction Set Architecture,” arXiv: 1608.03355v2, dated Feb. 17, 2017, or another quantum instruction language. For instance, the quantum machine instructions may be written in a format that can be executed by a broad range of quantum processing units or simulators. In some cases, a program may be expressed in high-level terms of quantum logic gates or quantum algorithms, in lower-level terms of fundamental qubit rotations and controlled rotations, or in another form. In some cases, a program may be expressed in terms of control signals (e.g., pulse sequences, delays, etc.) and parameters for the control signals (e.g., frequencies, phases, durations, channels, etc.). In some cases, a program may be expressed in another form or format. In some cases, a program may utilize Quil-T, described in the publication “Gain deeper control of Rigetti quantum processing units with Quil-T,” available at https://medium.com/rigetti/gain-deeper-control-of-rigetti-quantum-processors-with-quil-t-ea8945061e5b dated Dec. 10, 2020, which is hereby incorporated by reference in the present disclosure.

In some implementations, the servers 108 include one or more compilers that convert programs between formats. For example, the servers 108 may include a compiler that converts hardware-independent instructions to binary programs for execution by the quantum computing systems 103A, 103B. In some cases, a compiler can compile a program to a format that targets a specific quantum resource in the computer system 101. For example, a compiler may generate a different binary program (e.g., from the same source code) depending on whether the program is to be executed by the quantum computing system 103A or the quantum computing system 103B.

In some cases, a compiler generates a partial binary program that can be updated, for example, based on specific parameters. For instance, if a quantum program is to be executed iteratively on a quantum computing system with varying parameters on each iteration, the compiler may generate the binary program in a format that can be updated with specific parameter values at runtime (e.g., based on feedback from a prior iteration, or otherwise); the parametric update can be performed without further compilation. In some cases, a compiler generates a full binary program that does not need to be updated or otherwise modified for execution.

In some implementations, the servers 108 identifies quantum computing routines; generate a schedule for executing the quantum computing routines in a program; allocate computing resources in the computing system 101 according to the schedule; and delegate the program to the allocated computing resources. The servers 108 can receive, from each computing resource, output data from the execution of each program. Based on the output data, the servers 108 may generate additional programs that are then added to the schedule, output data that is provided back to a user device 110, or perform another type of action.

In some implementations, all or part of the computing system 101 operates as a hybrid computing environment. For example, quantum programs can be formatted as hybrid classical/quantum programs that include instructions for execution by one or more quantum computing resources and instructions for execution by one or more classical resources. The servers 108 can allocate quantum and classical computing systems in the hybrid computing environment, and delegate programs to the allocated computing resources for execution. The quantum computing resources in the hybrid environment may include, for example, one or more quantum processing units (QPUs), one or more quantum virtual machines (QVMs), one or more quantum simulators, or possibly other types of quantum resources. The classical computing systems in the hybrid environment may include, for example, one or more digital microprocessors, one or more specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), or other types of computing modules.

In some cases, the servers 108 can select the type of computing resource (e.g., quantum or classical) to execute an individual program, or part of a program, in the computing system 101. For example, the servers 108 may select a particular quantum processing unit (QPU) or other computing resource based on availability of the resource, speed of the resource, information or state capacity of the resource, a performance metric (e.g., process fidelity) of the resource, or based on a combination of these and other factors. In some cases, the servers 108 can perform load balancing, resource testing and calibration, and other types of operations to improve or optimize computing performance.

Each of the example quantum computing systems 103A, 103B shown in FIG. 1 can perform quantum computational tasks by executing quantum machine instructions (e.g., a binary program compiled for the quantum computing system). In some implementations, a quantum computing system can perform quantum computation by storing and manipulating information within quantum states of a composite quantum system. For example, qubits (i.e., quantum bits) can be stored in, and represented by, an effective two-level sub-manifold of a quantum coherent physical system. In some instances, quantum logic can be executed in a manner that allows large-scale entanglement within the quantum system. Control signals can manipulate the quantum states of individual qubits and the joint states of multiple qubits. In some instances, information can be read out from the composite quantum system by measuring the quantum states of the qubits. In some implementations, the quantum states of the qubits are read out by measuring the transmitted or reflected signal from auxiliary quantum devices that are coupled to individual qubits.

In some implementations, a quantum computing system can operate using gate-based models for quantum computing. For example, the qubits can be initialized in an initial state, and a quantum logic circuit comprised of a series of quantum logic gates can be applied to transform the qubits and extract measurements representing the output of the quantum computation. Individual qubits may be controlled by single-qubit quantum logic gates, and pairs of qubits may be controlled by two-qubit quantum logic gates (e.g., entangling gates that are capable of generating entanglement between the pair of qubits). In some implementations, a quantum computing system can operate using adiabatic or annealing models for quantum computing. For instance, the qubits can be initialized in an initial state, and the controlling Hamiltonian can be transformed adiabatically by adjusting control parameters to another state that can be measured to obtain an output of the quantum computation.

In some models, fault-tolerance can be achieved by applying a set of high-fidelity control and measurement operations to the qubits. For example, quantum error correction codes can be deployed to achieve fault-tolerant quantum computation. Other computational regimes may be used; for example, quantum computing systems may operate in non-fault-tolerant regimes. In some implementations, a quantum computing system is constructed and operated according to a scalable quantum computing architecture. For example, in some cases, the architecture can be scaled to a large number of qubits to achieve large-scale general purpose coherent quantum computing. Other architectures may be used; for example, quantum computing systems may operate in small-scale or non-scalable architectures.

The example quantum computing system 103A shown in FIG. 1 includes a quantum processing unit 102A and a control system 105A, which controls the operation of the quantum processing unit 102A. Similarly, the example quantum computing system 103B includes a quantum processing unit 102B and a control system 105B, which controls the operation of a quantum processing unit 102B. A quantum computing system may include additional or different features, and the components of a quantum computing system may operate as described with respect to FIG. 1 or in another manner.

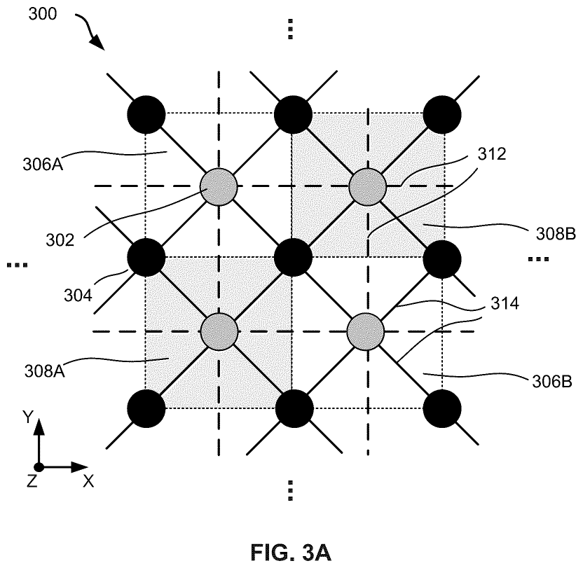

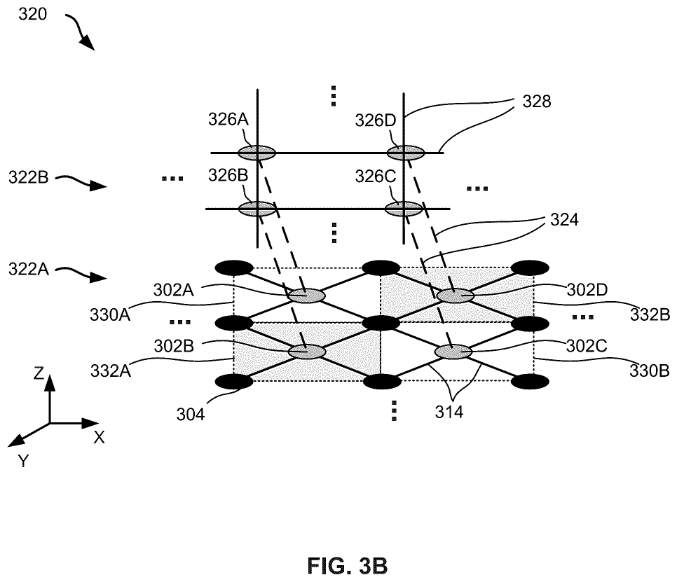

In some instances, all or part of the quantum processing unit 102A functions as a quantum processing unit, a quantum memory, or another type of subsystem. In some examples, the quantum processing unit 102A includes a superconducting quantum circuit system. The superconducting quantum circuit may include data qubit devices, stabilizer qubit devices, coupler devices, readout devices, and possibly other devices that are used to store and process quantum information. In some cases, multiple data qubit devices are operatively coupled to a single stabilizer check qubit device through respective coupler devices. In some implementations, the quantum processing unit 102A is implemented as the quantum processing unit 300, 320 shown in FIGS. 3A-3B, or in another manner. In certain examples, the qubit devices and the coupler devices are implemented as superconducting quantum circuit elements that include Josephson junctions, for example, in Superconducting QUantum Interference Device (SQUID) loops or other arrangements, and are controlled by radio-frequency signals, microwave signals, and bias signals delivered to the quantum processing unit 102A.

In some instances, a qubit device of the quantum processing unit 102A is a physical implementation of a multi-dimensional quantum system, e.g., a qudit. In some examples, a multi-level quantum system may be a two-level quantum system which includes two lowest energy levels (e.g., the ground state |0 [symbol] and a first excited state |1 [symbol] ) used as computational basis states for quantum computation. In some examples, a multi-level quantum system also includes higher energy levels (e.g., a second excited state |2 [symbol] or a third excited state |3 [symbol] ) used as computational basis states for quantum computation in some instances. It is noted that the term “qubit” used throughout the application is interchangeable with “qudit”.

In some instances, the quantum processing modules can include a superconducting quantum circuit that includes one or more quantum circuit devices. For instance, a superconducting quantum circuit may include qubit devices, readout resonator devices, Josephson junctions, or other quantum circuit devices. In some implementations, quantum circuit devices in a quantum processing unit can be collectively operated to define a single logical qubit. A logical qubit includes a quantum register, for instance multiple physical qubit devices, and associated circuitry, that supports physical operations which can be used to detect or correct errors associated with logical states in a quantum algorithm. Physical operations supported by the quantum register associated with a logical qubit may include single-qubit or multi-qubit quantum logic gates and readout mechanisms. Error detection or correction mechanisms associated with a logical qubit may be based on quantum error correction schemes such as the surface code, color code, Bacon-Shor codes, low-density parity check codes (LDPC), some combination of these, or others.

In some instances, a quantum error correction code for a quantum computing system can be applied when a quantum computing program is executed on logical qubits. In some instances, the quantum error correction code may be dynamic and can be tailored or modified by operation of the classical computing resources and the quantum computing resources in the computing system 101 during any stages of the execution of the quantum computing program. In some implementations, a quantum error correction code which are defined quantum error correction code parameters can be modified by updating the error-correcting code parameters. Target values and observed values of logical errors may be used to determine updated error-correcting-code parameters. The updated quantum error correction code can be applied when the quantum computing program is executed. In some instances, the quantum error correction code may be further updated during the execution of the quantum computing program at runtime; and the modified quantum error correction code parameters may be determined based on the target values and the observed values of the logical errors; and the observed values of the algorithmic errors associated with the execution of the quantum computing program.

The quantum processing unit 102A may include, or may be deployed within, a controlled environment. The controlled environment can be provided, for example, by shielding equipment, cryogenic equipment, and other types of environmental control systems. In some examples, the components in the quantum processing unit 102A operate in a cryogenic temperature regime and are subject to very low electromagnetic and thermal noise. For example, magnetic shielding can be used to shield the system components from stray magnetic fields, optical shielding can be used to shield the system components from optical noise, thermal shielding and cryogenic equipment can be used to maintain the system components at controlled temperature, etc.

In some implementations, the example quantum processing unit 102A can process quantum information by applying control signals to the qubits in the quantum processing unit 102A. The control signals can be configured to encode information in the qubits, to process the information by performing quantum logic gates or other types of operations, or to extract information from the qubits. In some examples, the operations can be expressed as single-qubit quantum logic gates, two-qubit quantum logic gates, or other types of quantum logic gates that operate on one or more qubits. A quantum logic circuit, which includes a sequence of quantum logic operations, can be applied to the qubits to perform a quantum algorithm. The quantum algorithm may correspond to a computational task, a hardware test, a quantum error correction procedure, a quantum state distillation procedure, or a combination of these and other types of operations.

The example control system 105A includes controllers 106A and signal hardware 104A. Similarly, control system 105B includes controllers 106B and signal hardware 104B. All or part of the control systems 105A, 105B can operate in a room-temperature environment or another type of environment, which may be located near the respective quantum processing units 102A, 102B. In some cases, the control systems 105A, 105B include classical computers, signaling equipment (microwave, radio, optical, bias, etc.), electronic systems, vacuum control systems, refrigerant control systems, or other types of control systems that support operation of the quantum processing units 102A, 102B.

The control systems 105A, 105B may be implemented as distinct systems that operate independent of each other. In some cases, the control systems 105A, 105B may include one or more shared elements; for example, the control systems 105A, 105B may operate as a single control system that operates both quantum processing units 102A, 102B. Moreover, a single quantum computing system may include multiple quantum processing units, which may operate in the same controlled (e.g., cryogenic) environment or in separate environments.

The example signal hardware 104A includes components that communicate with the quantum processing unit 102A. The signal hardware 104A may include, for example, waveform generators, amplifiers, digitizers, high-frequency sources, DC sources, AC sources, etc. The signal hardware may include additional or different features and components. In the example shown, components of the signal hardware 104A are adapted to interact with the quantum processing unit 102A. For example, the signal hardware 104A can be configured to operate in a particular frequency range, configured to generate and process signals in a particular format, or the hardware may be adapted in another manner.

In some instances, one or more components of the signal hardware 104A generate control signals, for example, based on control information from the controllers 106A. The control signals can be delivered to the quantum processing unit 102A during operation of the quantum computing system 103A. For instance, the signal hardware 104A may generate signals to implement quantum logic operations, readout operations, or other types of operations. As an example, the signal hardware 104A may include arbitrary waveform generators (AWGs) that generate electromagnetic waveforms (e.g., microwave or radiofrequency) or laser systems that generate optical waveforms. The waveforms or other types of signals generated by the signal hardware 104A can be delivered to devices in the quantum processing unit 102A to operate qubit devices, readout devices, bias devices, coupler devices, or other types of components in the quantum processing unit 102A.

In some instances, the signal hardware 104A receives and processes signals from the quantum processing unit 102A. The received signals can be generated by the execution of a quantum program on the quantum computing system 103A. For instance, the signal hardware 104A may receive signals from the devices in the quantum processing unit 102A in response to readout or other operations performed by the quantum processing unit 102A. Signals received from the quantum processing unit 102A can be mixed, digitized, filtered, or otherwise processed by the signal hardware 104A to extract information, and the information extracted can be provided to the controllers 106A or handled in another manner. In some examples, the signal hardware 104A may include a digitizer that digitizes electromagnetic waveforms (e.g., microwave or radiofrequency) or optical signals, and a digitized waveform can be delivered to the controllers 106A or to other signal hardware components. In some instances, the controllers 106A process the information from the signal hardware 104A and provide feedback to the signal hardware 104A; based on the feedback, the signal hardware 104A can in turn generate new control signals that are delivered to the quantum processing unit 102A.

In some implementations, the signal hardware 104A includes signal delivery hardware that interfaces with the quantum processing unit 102A. For example, the signal hardware 104A may include filters, attenuators, directional couplers, multiplexers, diplexers, bias components, signal channels, isolators, amplifiers, power dividers, and other types of components. In some instances, the signal delivery hardware performs preprocessing, signal conditioning, or other operations to the control signals to be delivered to the quantum processing unit 102A. In some instances, signal delivery hardware performs preprocessing, signal conditioning, or other operations on readout signals received from the quantum processing unit 102A.

The example controllers 106A communicate with the signal hardware 104A to control the operation of the quantum computing system 103A. The controllers 106A may include classical computing hardware that directly interfaces with components of the signal hardware 104A. The example controllers 106A may include classical processors, memory, clocks, digital circuitry, analog circuitry, and other types of systems or subsystems. The classical processors may include one or more single- or multi-core microprocessors, digital electronic controllers, special purpose logic circuitry, e.g., an FPGA (field programmable gate array) or an ASIC (application specific integrated circuit), or other types of data processing apparatus. The memory may include any type of volatile or non-volatile memory or another type of computer storage medium. The controllers 106A may also include one or more communication interfaces that allow the controllers 106A to communicate via the local network 109 and possibly other channels. The controllers 106A may include additional or different features and components.

In some implementations, the controllers 106A include memory or other components that store quantum state information, for example, based on qubit readout operations performed by the quantum computing system 103A. For instance, the states of one or more qubits in the quantum processing unit 102A can be measured by qubit readout operations, and the measured state information can be stored in a cache or other type of memory system in one or more of the controllers 106A. In some cases, the measured state information is subsequently used in the execution of a quantum program, a quantum error correction procedure, a quantum processing unit (QPU) calibration or testing procedure, or another type of quantum process.

In some implementations, the controllers 106A include memory or other components that store a quantum program containing quantum machine instructions for execution by the quantum computing system 103A. In some instances, the controllers 106A can interpret the quantum machine instructions and perform hardware-specific control operations according to the quantum machine instructions. For example, the controllers 106A may cause the signal hardware 104A to generate control signals that are delivered to the quantum processing unit 102A to execute the quantum machine instructions.

In some instances, the controllers 106A extract qubit state information from qubit readout signals, for example, to identify the quantum states of qubits in the quantum processing unit 102A or for other purposes. For example, the controllers may receive the qubit readout signals (e.g., in the form of analog waveforms) from the signal hardware 104A, digitize the qubit readout signals, and extract qubit state information from the digitized signals. In some cases, the controllers 106A compute measurement statistics based on qubit state information from multiple shots of a quantum program. For example, each shot may produce a bitstring representing qubit state measurements for a single execution of the quantum program, and a collection of bitstrings from multiple shots may be analyzed to compute quantum state probabilities.

In some implementations, the controllers 106A include one or more clocks that control the timing of operations. For example, operations performed by the controllers 106A may be scheduled for execution over a series of clock cycles, and clock signals from one or more clocks can be used to control the relative timing of each operation or groups of operations. In some implementations, the controllers 106A may include classical computer resources that perform some or all of the operations of the servers 108 described above. For example, the controllers 106A may operate a compiler to generate binary programs (e.g., full or partial binary programs) from source code; the controllers 106A may include an optimizer that performs classical computational tasks of a hybrid classical/quantum program; the controllers 106A may update binary programs (e.g., at runtime) to include new parameters based on an output of the optimizer, etc.

The other quantum computing system 103B and its components (e.g., the quantum processing unit 102B, the signal hardware 104B, and controllers 106B) can be implemented as described above with respect to the quantum computing system 103A; in some cases, the quantum computing system 103B and its components may be implemented or may operate in another manner.

In some implementations, the quantum computing systems 103A, 103B are disparate systems that provide distinct modalities of quantum computation. For example, the computer system 101 may include both an adiabatic quantum computing system and a gate-based quantum computer system. As another example, the computer system 101 may include a superconducting circuit-based quantum computing system and an ion trap-based quantum computer system. In such cases, the computer system 101 may utilize each quantum computing system according to the type of quantum program that is being executed, according to availability or capacity, or based on other considerations.

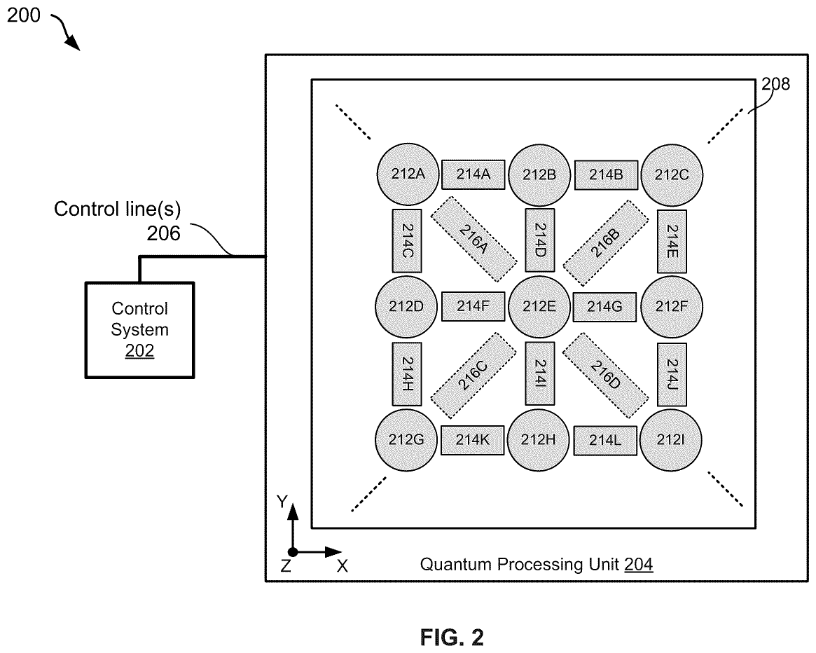

FIG. 2 is a schematic diagram showing aspects of an example quantum computing system 200. The example quantum computing system 200 shown in FIG. 2 may be deployed as one or more of the quantum computing systems (e.g., 103A, 103B) shown in FIG. 1, or the quantum computing system 200 may be deployed in another type of computing environment. As shown in FIG. 2, the example quantum computing system 200 includes a control system 202 and a quantum processing unit 204. The example quantum processing unit 204 may be implemented as the quantum processing unit 102 in FIG. 1. The example quantum computing system 200 may include additional or different features, and the components may be arranged in another manner.

In some instances, the quantum processing unit 204 is a superconducting quantum processing unit. In this case, the example quantum processing unit 204 includes a device array, which includes superconducting quantum circuit elements arranged in a two-dimensional layout. Twenty-five of the superconducting quantum circuit elements in the device array are shown in FIG. 2. In particular, the quantum processing unit 204 includes nine qubit devices 212 and sixteen coupling elements 214. The qubit devices 212 may be implemented as transmon qubit devices, flux qubit devices, flatsonium qubit devices, fluxonium qubit devices, or other types of qubit devices. The qubit devices 212 may be implemented as fixed-frequency qubit devices or tunable-frequency qubit devices. The coupling elements 214 may be implemented as fixed-frequency coupler devices, tunable-frequency coupler devices, LC resonator devices, or other types of coupler devices. In some instances, a coupling element between a pair of qubit devices may be capacitive, inductive, or galvanic. In some implementations, the quantum processing unit 204 shown in FIG. 2 is part (e.g., a two-dimensional grid on one layer) of a three-dimensional lattice, which includes multiple layers of two-dimensional grids shown in FIG. 2. A coupling between two qubit devices from two distinct layers may be achieved by a static capacitive coupling, a tunable-frequency coupling, or other types of coupling.

In the example shown in FIG. 2, the quantum circuit devices are arranged in a rectilinear (e.g., rectangular or square) array that extends in two spatial dimensions (in the plane of the page), and each qubit device 212 is communicably coupled with four other nearest-neighbor qubit devices 212 through a respective coupling element 214. For example, the qubit device 212B is coupled with qubit devices 212A and 212C through respective coupling elements 214A and 214B and qubit device 212A is also coupled with qubit device 212D through a coupling element 214C. In other words, two coupling elements 214A, 214C, are associated with the qubit device 212A. In some instances, the qubit device 212A may be coupled to other qubit devices in the same layer or in different layers. In some instances, more coupling elements 214 may be associated with a qubit device 212. For example, four coupling elements 214D, 214F, 214I, and 214G are associated with the qubit device 212E. In some implementations, the quantum circuit devices in the quantum processing unit 204 can be arranged in another type of ordered array. In some instances, the rectilinear array also extends in a third spatial dimension (in/out of the page), for example, to form a cubic array or another type of three-dimensional array. In this case, a qubit device may have a higher connectivity according to the number of the associated coupling elements. For example, the qubit device 212E may include additional coupling elements configured to provide coupling with other qubit devices residing on different layers of a three-dimensional lattice.

In some implementations, the qubit device 212E is communicably coupled to qubit devices 212A, 212C, 212G, 212I directly through respective coupling elements 216A, 216B, 216C, 216D. In this case, the four coupling elements 216A, 216B, 216C, 216D are also associated with the qubit device 212E. In some instances, the qubit devices 212A, 212C, 212E, 212G, 212I are stabilizer check qubit devices; and the qubit devices 212B, 212D, 212F, 212H are data qubit devices. Each of the stabilizer check qubit devices has an in-plane connectivity of eight; and each of the data qubit devices has an in-plane connectivity of four. In some examples, each of the stabilizer check qubit devices may be also coupled to other stabilizer check qubit devices in neighboring layers (e.g., as shown in FIG. 3B).

In some aspects, parametrically activated quantum logic gates are supported in a two-dimensional or three-dimensional architecture (e.g., an architecture where quantum circuit devices are distributed over two or three spatial dimensions). For instance, the positions of the qubit devices within the example quantum processing unit 204 may define one or more two-dimensional spatial arrays in a plane, and readout resonators associated with the qubit devices can be positioned within another plane (e.g., on another substrate or on another layer of the same substrate). In some cases, the qubit devices 212 on one substrate 208 are electronically coupled to readout resonator devices on another substrate through conductive signal vias, interconnections, cap wafers, or other types of structures. Accordingly, frequency allocation schemes can be defined for two-dimensional and three-dimensional processor architectures.

In some implementations, the control system 202 interfaces with the quantum processing unit 204 through signal hardware that includes control lines 206. The control system 202 and control lines 206 may be implemented, for example, as described with respect to the controller 106 and the signal hardware 104 of the example control system 105 shown in FIG. 1, or in another manner.

In the example quantum processing unit 204 shown in FIG. 2, each of the qubit devices 212 can be encoded with a single bit of quantum information (a qubit). Each of the qubit devices has two eigenstates that are used as computational basis states, and each qubit device can transition between its computational basis states or exist in an arbitrary superposition of its computational basis states. In some examples, two lowest energy levels (e.g., the ground state |0 [symbol] and a first excited state | 1 [symbol] ) of each qubit device are defined as a qubit and used as computational basis states for quantum computation. In some examples, higher energy levels (e.g., a second excited state |2 [symbol] or a third excited state |3 [symbol] ) are also defined by a multi-state quantum circuit device; and may be used for quantum computation in some instances.

In some implementations, the qubits of the respective qubit devices can be manipulated by control signals, or read by readout signals, generated by the control system 202. The qubit devices 212 can be controlled individually, for example, by communicating control signals to the respective qubit devices. In some cases, a coupling element 214 may be a tunable-frequency coupler device. In this case, the coupling element between two qubit devices 212 can be activated or deactivated by tuning the transition frequency of the associated tunable-frequency coupler device. Control signals can be communicated to the qubit devices 212 and the associated tunable-frequency coupler devices. In some implementations, associated tunable-frequency coupler devices include those that are in the same layer or between different layers in a three-dimensional lattice. In some cases, readout devices can detect the qubits of the qubit devices, for example, by interacting directly with the respective qubit devices.

In some examples, a tunable-frequency qubit device includes a superconducting circuit loop (e.g., a SQUID loop) that receives a magnetic flux which can tune the transition frequency of the tunable-frequency qubit device. In some instances, the transition frequency can be tuned within a range of frequencies (e.g., between a maximum transition frequency and a minimum transition frequency). The superconducting circuit loop may include two Josephson junctions, and the tunable-frequency qubit device may also include a shunt capacitor connected in parallel with each of the two Josephson junctions. In certain instances, the energy difference E between any two adjacent energy levels in a qubit device can be represented as a transition frequency ω of the qubit device (e.g., according to ω=E/h). In some examples, a transition frequency is tunable, for example, by application of a magnetic flux. In this case, the transition frequency may be defined at least in part by Josephson energies of the two Josephson junctions, a capacitance of the shunt capacitor, and a magnetic flux threading the superconducting circuit loop. A qubit operating frequency of the tunable-frequency qubit device is a transition frequency at which the tunable-frequency qubit device operates.

In the example shown in FIG. 2, each qubit device 212 has one or more tunable transition frequencies. In some cases, the transition frequencies of the tunable-frequency qubit devices can be tuned by applying respective offset fields to the respective tunable-frequency qubit devices. Each of the offset fields can be, for example, a magnetic flux bias, a DC electrical voltage, or another type of field.

In some instances, information is encoded in the qubit devices 212 in the quantum processing unit 204, and the information can be processed by operation of the qubit devices 212. For instance, input information can be encoded in the computational states or computational subspaces defined by some or all of the qubit devices in the quantum processing unit 204. The information can be processed, for example, by applying a quantum program or other operations to the input information. The quantum program may be decomposed as a sequence of native quantum logic gates or instruction sets that are executed by quantum circuit devices in the quantum processing unit 204 over a series of clock cycles. In some cases, information is processed in another manner. Processing the information encoded in the qubit devices can produce output information that can be extracted from the qubit devices. The output information can be extracted, for example, by performing state tomography or individual readout operations. In some instances, the output information is extracted over multiple clock cycles or in parallel with the processing operations.

As shown in FIG. 2, the control system 202 is coupled to each of the superconducting quantum circuit elements (e.g., the qubit devices 212 and the coupling elements 214) in the quantum processing unit 204 through one or more control lines 206. For example, the control system 202 may communicate control signals to and receive readout signals from the quantum processing unit 204. The control signals communicated from the control system 202 to the qubit devices 212 can be configured to modulate, increase, decrease, or otherwise manipulate the qubit operating frequencies of the qubit devices 212. For example, a control signal may include a flux bias signal to tune the transition frequency of the tunable-frequency qubit device. For another example, a control signal may include a flux modulation signal that modulates a magnetic flux experienced by the tunable-frequency qubit device, and thus the transition frequency of the tunable-frequency qubit device. In some implementations, a control signal can be a direct current (DC) signal, an alternating current (AC) signal (e.g., superposed with a DC signal) communicated from the control system 202 to a qubit device 212. Other types of control signals may be used.

In some cases, the control lines 206 may include a flux bias device or another type of flux bias element that is inductively coupled to the superconducting circuit loop of a tunable-frequency qubit device to control the magnetic flux through a superconducting circuit loop in the tunable-frequency qubit device. The control signal may cause the flux-bias device to modulate the magnetic flux at a modulation frequency. In some instances, the modulation frequency of the magnetic flux may be the same as the flux modulation frequency ωₘ of the flux modulation signal, or the modulation frequency of the magnetic flux may have a different value.

In some implementations, a transition frequency (ω_{T}) of a tunable-frequency qubit device can be tuned by tuning a magnetic flux threading a superconducting circuit loop in the tunable-frequency qubit device. A magnetic flux can be modulated by communicating a flux modulation signal from the control system 202 to a flux bias element in a flux bias control line. Consequently, the transition frequency ω_{T} of the tunable-frequency qubit device can be modulated. In some instances, a flux modulation signal includes a flux modulation frequency (ωₘ) causing the transition frequency ω_{T} of a tunable-frequency qubit device to oscillate at a harmonic of the flux modulation frequency ωₘ. In some instances, the transition frequency ω_{T} under modulation is in a range of qubit operation frequencies which is defined by a tunability of a tunable-frequency qubit device. In some instances, a control signal may include a qubit drive signal which can drive the transition between two energy states (e.g., between the ground state and the first excited state) causing a population exchange between the ground state and the excited state.

In some implementations, control signals for a tunable-frequency qubit device including a flux modulation signal and a qubit drive signal can be communicated to the tunable-frequency qubit device on two separate control lines, e.g., a flux bias control line and a qubit drive control line. In some instances, the flux bias control line can be inductively coupled to the superconducting circuit loop to control the magnetic flux and thereby control the transition frequencies of the tunable-frequency qubit device. In certain examples, the qubit drive control line can be capacitively coupled to the tunable-frequency qubit device, e.g., through one or more qubit electrodes of the tunable-frequency qubit device. In this case, when a qubit drive signal and a flux modulation signal are communicated to the tunable-frequency qubit device through the respective control lines, a single-qubit quantum logic gate can be applied to a qubit defined by the tunable-frequency qubit device. In some instances, the flux modulation signal and the qubit drive signal may be communicated on a single control line that is both inductively and capacitively coupled to the tunable-frequency qubit device. In some instances, the transition frequency of the tunable-frequency qubit device or the tunable-frequency coupler device may be controlled in another manner.

In some implementations, the control system 202 (e.g., a gate calibration module), or another type of system associated with the quantum computing system 200, determines gate parameters for applying quantum logic gates in the quantum processing unit 204 by executing a gate calibration process. For example, the gate parameters may be determined by a gate calibration process defined in software, firmware or hardware, or a combination thereof. In some instances, initial values of the gate parameters for applying quantum logic gates of unitary operations in a quantum logic circuit may be selected by the control system 202 or obtained by the control system 202 (e.g., from a user device).

In some implementations, initial values of control parameters of control signals, e.g., the flux bias amplitude, the flux modulation frequency ωₘ, the flux modulation amplitude δω, the duration of the interaction produced by the flux modulation signal, or other control parameters of other control signals are determined based on the device parameters, e.g., transition frequencies, anharmonicities, data from a calibration or other test procedure, or a combination of these, the gate parameters, and other information.

In some cases, the control system 202 may execute a device measurement process, e.g., when the quantum processing unit 204 is first installed for use in the quantum computing system 200, and the device measurement process may be repeated at other times (e.g., as needed, periodically, according to a calibration schedule, etc.). For instance, a device measurement module may execute a measurement process that obtains device parameters of the quantum circuit devices in the quantum processing unit 204. The device parameters may be obtained by the device measurement process, for example, based on measurements of the quantum processing unit 204, based on a circuit specification of the quantum processing unit 204, based on analytical or numerical calculations, or otherwise. The device parameters may include, for example, qubit frequencies (e.g., a tunable range) and an anharmonicity for each tunable-frequency qubit device. In some instances, device parameters of the superconducting quantum circuit elements obtained from the device measurement process may be stored in a database, which can be used for determining initial values of control parameters of control signals to execute quantum logic gates on respective quantum circuit devices in the quantum processing unit 204.

In some implementations, the control system 202, or another type of system associated with the quantum computing system 200, further determines improved or optimal values of the control parameters of the control signals for executing quantum logic gates on respective quantum circuit devices in the quantum processing unit 204. For example, the improved or optimal values of the gate parameters may be determined by performing a hybrid variational quantum algorithm, or other types of quantum algorithm.

In some instances, when a quantum program is defined and received by a computing system, a subset of superconducting quantum circuit elements of the quantum processing unit 204 can be selected for performing the quantum program, for example, by operation of the server 108 of the computing system 101 in FIG. 1. As shown in FIG. 2, quantum circuit devices are selected for performing a quantum program.

The example quantum processing unit 204 shown in FIG. 2 resides on the top surface of a substrate 208. In certain instances, the substrate 208 may be an elemental semiconductor, for example silicon (Si), germanium (Ge), selenium (Se), tellurium (Te), or another elemental semiconductor. In some instances, the substrate 208 may also include a compound semiconductor such as aluminum oxide (sapphire), silicon carbide (SiC), gallium arsenic (GaAs), indium arsenide (InAs), indium phosphide (InP), silicon germanium (SiGe), silicon germanium carbide (SiGeC), gallium arsenic phosphide (GaAsP), gallium indium phosphide (GaInP), or another compound semiconductor. In some instances, the substrate 208 may also include a superlattice with elemental or compound semiconductor layers. In certain instances, the substrate 208 includes an epitaxial layer. In some examples, the substrate 208 may have an epitaxial layer overlying a bulk semiconductor or may include a semiconductor-on-insulator (SOI) structure.

In some instances, qubit electrodes and the ground plane of quantum circuit devices (e.g., qubit devices and coupling elements) include superconductive materials and can be formed by patterning one or more superconductive (e.g., superconducting metal) layers or other materials on the surface of the substrate 208. In some implementations, each of the one or more superconductive layers include a superconducting metal, such as aluminum (Al), niobium (Nb), tantalum (Ta), titanium (Ti), vanadium (V), tungsten (W), zirconium (Zr), or another superconducting metal. In some implementations, each of the one or more superconductive layers may include a superconducting metal alloy, such as molybdenum-rhenium (Mo/Re), niobium-tin (Nb/Sn), or another superconducting metal alloy. In some implementations, each of the superconductive layers may include a superconducting compound material, including superconducting metal nitrides and superconducting metal oxides, such as titanium-nitride (TiN), niobium-nitride (NbN), zirconium-nitride (ZrN), hafnium-nitride (HfN), vanadium-nitride (VN), tantalum-nitride (TaN), molybdenum-nitride (MoN), yttrium barium copper oxide (Y—Ba—Cu—O), or another superconducting compound material. In some instances, the qubit electrodes and the ground plane may include multilayer superconductor-insulator heterostructures.

In some implementations, the qubit electrodes and the ground plane of the quantum circuit devices are fabricated on the top surface of the substrate 208 and patterned using a microfabrication process or in another manner. For example, the qubit electrodes and the ground plane may be formed by performing at least some of the following fabrication steps: using chemical vapor deposition (CVD), physical vapor deposition (PVD), atomic layer deposition (ALD), spin-on coating, and/or other suitable techniques to deposit respective superconducting layers on the substrate 208; and performing one or more patterning processes (e.g., a lithography process, a dry/wet etching process, a soft/hard baking process, a cleaning process, etc.) to form openings in the respective superconducting layers.

FIG. 3A is a schematic diagram showing aspects of a physical layout of an example quantum processing circuit 300. In some implementations, the quantum processing unit 300 with the physical layout shown in FIG. 3A is used for supporting in-situ tuning of a quantum error correction code. The quantum processing circuit 300 is part of a quantum processing unit in a computing system, e.g., the quantum processing unit 102, 204 of the computing system 101 and 200 of FIGS. 1 and 2. As shown in FIG. 3A, the quantum processing circuit 300 includes four stabilizer check qubit device 302 and nine data qubit devices 304 arranged on a two-dimensional X-Y plane in a square, diamond, rectangular, or another pattern. These qubit devices shown in FIG. 3A are configured to store partial information about a logical qubit. In some instances, the quantum processing circuit 300 may include more stabilizer check qubit devices 302 and data qubit devices 304. The data qubit devices 304 and the stabilizer check qubit devices 302 reside on the same layer.

As shown in FIG. 3A, each data qubit device 304 is operably coupled to four neighboring stabilizer check qubit devices 302; and each stabilizer check qubit device 302 is communicably coupled to four data qubit devices 304 through respective coupling elements 314 which are represented by solid lines. The in-plane connectivity of the data qubit devices 304 in the quantum processing circuit 300 is four. The coupling elements 314 may be implemented as the coupling elements 214 shown in FIG. 2 or in another manner.

In some implementations, the stabilizer check qubit devices 302 are used to measure the X or Z type observables from the coupled respective data qubit devices 304 via entangling quantum logic gates (e.g., a sequence of CNOT or CZ gates) and corresponding control operations (e.g., to enable or disable coupling elements 314). As shown in FIG. 3A, each of the stabilizer check qubit devices 302 is further operably coupled with four neighboring stabilizer check qubit devices 302 through respective coupling elements 312 which are represented by broken lines. In this case, the connectivity of a stabilizer check qubit devices 304 on the XY plane is eight. In other words, each of the stabilizer check qubit devices 302 is operably coupled to four neighboring data qubit devices 304 and four neighboring stabilizer check qubit devices 302 through in-plane coupling elements 314, 312 that are on the same X-Y plane.

In some implementations, a subset of the data qubit devices 304 and a subset of the stabilizer check qubit devices 302 in the quantum processing circuit 300 are connected to define a logical qubit. In particular, the subset of the data qubit devices 304 and the subset of the stabilizer check qubit devices 302 in the quantum processing circuit 300 are connected in an error correction pattern with planar code patches 306A, 306B, 308A, 308B where a quantum error correction code can be applied. As shown in FIG. 3A, each of the planar code patches 306A, 306B, 308A, 308B are used for a X-type or Z-type stabilizer measurement; and each of the planar code patches 306A, 306B, 308A, 308B includes four data qubit devices 304 and one stabilizer check qubit device 302. In this case, each of the planar code patches 306A, 306B, 308A, 308B in the error correction pattern corresponds to a weight-four X-type or Z-type stabilizer measurement in a quantum error correction code. When the quantum error correction code is applied on the logical qubit, the quantum error correction code includes equal numbers of weight-four X-type and Z-type stabilizer measurements. In this case, a relative weight between the X-type and Z-type stabilizer measurements in the quantum error correction code for the logical qubit is one, e.g., the number of data qubit devices used for X-type stabilizer measurements equals to the number of data qubit devices used for Z-type stabilizer measurements.

In some instances, when a coupling element 312 between two or more neighboring stabilizer check qubit devices 302 is a tunable coupler device, coupling between the two or more neighboring stabilizer check qubit devices 302 can be tuned. In some implementations, when a coupling element 312 is activated and a two-qubit quantum logic gate is applied between the two coupled stabilizer check qubit devices 302, data qubit devices 304 from the two neighboring patches 306A, 308B, which are previously for different types of stabilizer measurements, can be used for the same type of stabilizer measurement. For example, when two neighboring patches are merged, the merged patch may be used for an X-type stabilizer measurement. In some instances, the merged patch includes six data qubit devices 304 and two stabilizer check qubit devices 302; and the merged patch corresponds to a weight-six X-type stabilizer measurement. In this case, the number of data qubit devices for the X-type stabilizer measurement may be greater than the number of data qubit devices for the Z-type stabilizer measurement in the quantum error correction code. The relative weight between the X-type stabilizer measurement and the Z-type stabilizer measurement is greater than one.

FIG. 3B is a schematic diagram showing aspects of a physical layout of an example quantum processing circuit 320. In some implementations, the quantum processing unit 320 with the physical layout shown in FIG. 3B is used for supporting in-situ tuning of logical qubit definitions. The quantum processing circuit 320 is part of a quantum processing unit in a computing system, e.g., the quantum processing unit 102, 204 of the computing system 101 and 200 of FIGS. 1 and 2. As shown in FIG. 3B, the quantum processing circuit 320 includes eight stabilizer check qubit device 302 and nine data qubit devices 304 arranged on a three-dimensional lattice. The three-dimensional lattice 320 includes two layers 322A, 322B. A first layer 322A includes four stabilizer check qubit device 302 and nine data qubit devices 304; and a second layer 322B includes four stabilizer check qubit devices 326. As shown in FIG. 3B, the second layer 322B only includes stabilizer check qubit devices 326 and does not include any data qubit devices. These qubit devices shown in FIG. 3B are configured to store partial information of a logical qubit. In some instances, the first layer 322A may include more stabilizer check qubit devices 302; the second layer 322B may include more stabilizer check qubit devices 326; and the layer 322A may include more data qubit devices 304.

As shown in FIG. 3B, each data qubit device 304 in the first layer 322A is further communicably coupled to four neighboring stabilizer check qubit devices 302 in the same layer on the same X-Y plane; and each stabilizer check qubit device 302 is communicably coupled to four data qubit devices 304 through respective in-plane coupling elements 314 which are represented by solid lines. The in-plane connectivity of the data qubit devices 304 in the quantum processing circuit 320 is four. The stabilizer check qubit device 302 is not coupled to neighboring stabilizer check qubit devices 302 in the same layer 322A. The coupling elements 314 may be implemented as the coupling elements 214 shown in FIG. 2 or in another manner.

In some implementations, a subset of the data qubit devices 304 and a subset of the stabilizer check qubit devices 302 in the first layer 322A are connected to define a logical qubit. In particular, the subset of the data qubit devices 304 and the subset of the stabilizer check qubit devices 302 in the quantum processing circuit 320 are connected in an error correction pattern with planar code patches 330A, 330B, 332A, 332B where a quantum error correction code can be applied. The stabilizer check qubit device 302 is used to measure the X or Z type observables from the coupled respective data qubit devices 304 via entangling quantum logic gates and corresponding control operations (e.g., to enable or disable coupling elements 314). As shown in FIG. 3B, each of the planar code patches 330A, 330B, 332A, 332B are used for a X-type or Z-type stabilizer measurement; and each of the planar code patches 330A, 330B, 332A, 332B includes four data qubit devices 304 and one stabilizer check qubit device 302. In this case, each of the planar code patches 330A, 330B, 332A, 332B in the error correction pattern corresponds to a weight-four X-type or Z-type stabilizer measurement in a quantum error correction code. When the quantum error correction code is applied on the logical qubit, the quantum error correction code includes equal numbers of weight-four X-type and Z-type stabilizer measurements. In this case, a relative weight between the X-type and Z-type stabilizer measurements in the quantum error correction code for the logical qubit is one, e.g., the number of data qubit devices used for X-type stabilizer measurements equals to the number of data qubit devices used for Z-type stabilizer measurements.

As shown in FIG. 3B, each of the stabilizer check qubit devices 302 in the first layer 322A is communicably coupled to a stabilizer check qubit device 302 on the second layer 322B. As shown in FIG. 3B, a stabilizer check qubit device 302 in the second layer 322B is communicably coupled with a stabilizer check qubit device 302 in the first layer 322A through respective out-of-plane coupling elements 324 which are represented by broken lines. In this case, the connectivity of a stabilizer check qubit devices 304 in the first layer 322A is five. In other words, each of the stabilizer check qubit devices 302 is communicably coupled with four neighboring data qubit devices 304 in the same layer 322A and one neighboring stabilizer check qubit devices 302 in the distinct layer 322B.

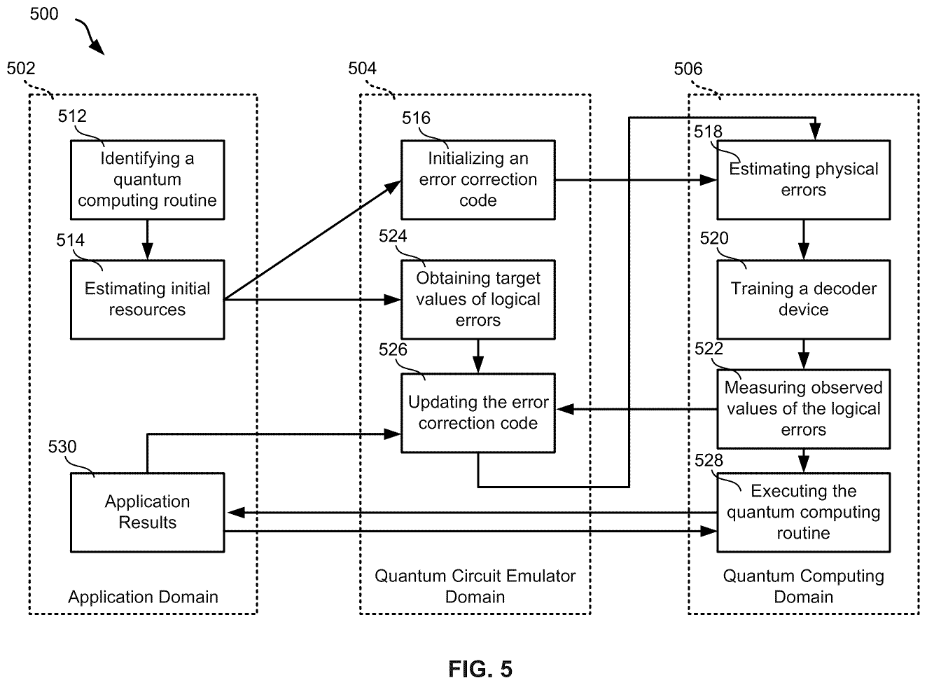

As shown in FIG. 3B, each of the stabilizer check qubit devices 326 in the second layer 322B are coupled to four neighboring stabilizer check qubit devices 326 through respective in-plane coupling elements 328 represented by solid lines. In other words, each of the stabilizer check qubit devices 326 in the second layer 322B has a connectivity of five. In some instances, each of the stabilizer check qubit devices 326 in the second layer 322B may be operably coupled to more stabilizer check qubit devices. In some instances, the in-plane coupling elements 328 and the out-of-plane coupling elements 324 may be implemented as the coupling elements 214, 216 in FIG. 2 or in another manner. In some implementations, an out-of-plane coupling element 324 is a parallel-plate capacitor with a vacuum gap or another type of coupling element. In some implementations, the in-plane coupling elements 328 and the out-of-plane coupling elements 324 are tunable-frequency coupling elements which can be activated or deactivated according to the quantum error correction code (e.g., during operation 526 in the example process 500 in FIG. 5).

In some implementations, the stabilizer check qubit device 302, the data qubit device 304 and the in-plane coupling elements 314 in the first layer 322A of the quantum processing circuit 320 are fabricated on a layer (e.g., a surface of a device wafer). In some instances, the stabilizer check qubit devices 326 and the in-plane coupling elements 328 in the second layer 322B of the quantum processing circuit 320 may be fabricated on a different layer, e.g., a distinct surface of the same device wafer, a surface of a cap wafer, or in another manner.

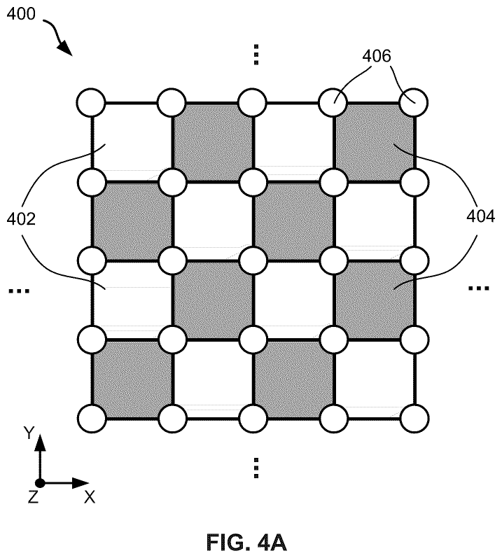

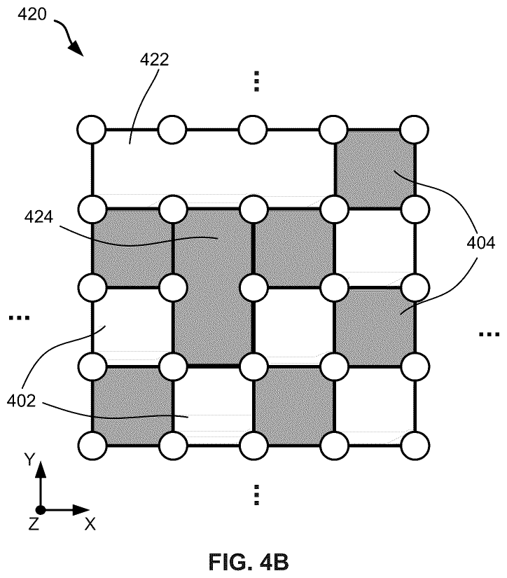

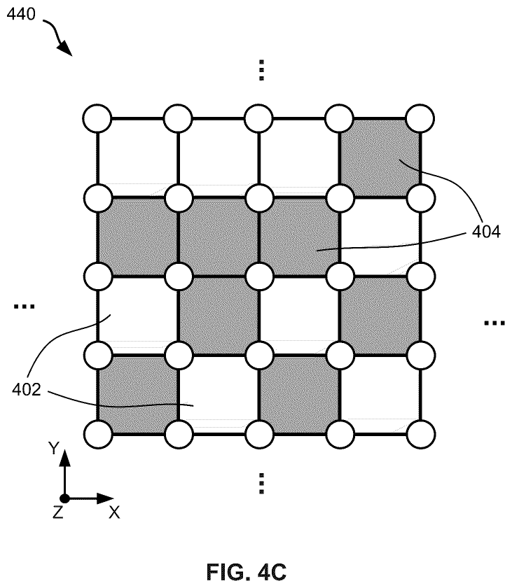

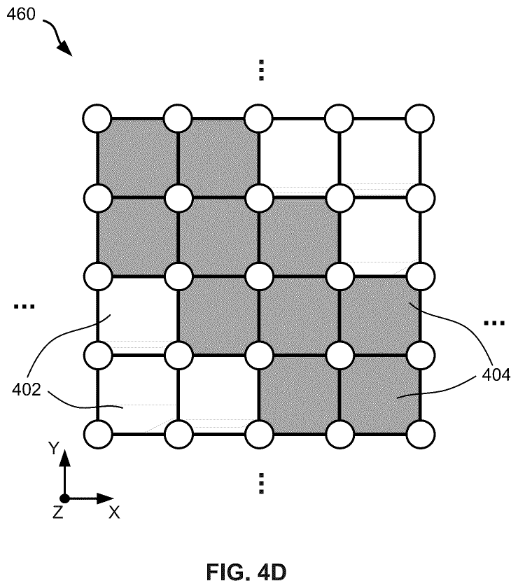

In some implementations, the quantum processing units with the example physical layouts 300, 320 can enable a full extent of two-dimensional compass codes to be achieved on a planar, bi-planar, or other multi-planar geometry. In particular, a quantum error correction code can be initialized, for instance, as a surface code including patches of quantum error correction codes (e.g., X-type or Z-type stabilizer check) defined on a 2D or a 3D lattice of qubit devices of a quantum processing unit; and one or more error correction biases can be introduced in the quantum error correction code by varying proportion and/or location of specific patches of X and/or Z type stabilizer measurements such that the stabilizer measurement patterns of the quantum error correction code can be altered, modified, and updated. FIG. 4A shows a quantum error correction code with same number of X-type stabilizer measurements and Z-type stabilizer measurements; and FIG. 4B shows an updated quantum error correction code with six Z-type stabilizer measurements represented by patches 402, 422 and seven X-type stabilizer measurements represented by patches 404, 424. Tuning the quantum error correction code by tuning the error correction pattern can be achieved by operation of the coupling elements 312 and the pairs of the stabilizer check qubit devices 302 in FIG. 3A, by operation of the coupling elements 324, 328 and the stabilizer check qubit devices 302, 326 (e.g., a chain of stabilizer check qubit devices 302A-326A-326D-302D) in FIG. 3B, or in another manner.

In some instances, the stabilizer check qubit devices 326 in the second layer 322B may be configured in another manner. For example, each of the stabilizer check qubit devices 326 may be operably coupled to two or more stabilizer check qubit devices 302 in the first layer 322A. In this case, a stabilizer check qubit device 302 may be communicably coupled to another stabilizer check qubit device 302 in the first layer 322A through one stabilizer check qubit device 326 in the second layer 322B. In some instances, the second layer 322B may include no stabilizer check qubit devices 326 and only includes the in-plane coupling elements 328 which are coupled to respective pairs of stabilizer check qubit devices 302 in the first layer 322A through respective out-of-plane coupling elements 324 to allow the two stabilizer check qubit devices 302 in the first layer 322A to be coupled to one another.

The state of stabilizer check qubit devices 302 can be swapped in a fault-tolerant manner along the interior of a single high-weight stabilizer measurement, avoiding the need for non-local or arbitrary-weight entangling gates, albeit with the penalty of a physical gate. In some implementations, a relative weight of a stabilizer measurement is defined by the number of the specific type (Z- or X-type) Pauli operators, each of which is applied between a pair of a data qubit device and a stabilizer check qubit device. In certain instances, a relative weight of stabilizer measurements for a logical qubit is defined by a ratio between a first number of data qubit devices participating in a first type of stabilizer measurement relative to a second number of data qubit devices participating in a second type of stabilizer measurement. For example, the quantum error correction pattern in FIG. 4A has the same number of data qubit devices for X-type and Z-type stabilizer measurements; and the relative weight for stabilizer measurement associated with the quantum error correction pattern 400 equals one. For another example, the quantum error correction pattern in FIG. 4B has 24 data qubit devices for Z-type stabilizer measurement and 30 data qubits for X-type stabilizer measurement; and the relative weight for stabilizer measurement associated with the error correction pattern 420 equals 0.8. In other words, the quantum error correction pattern 420 has comparatively more weight on X-type error correction and can be used on logical qubits that contains more X-type errors and Z-type errors.

In some implementations, when a relative weight of stabilizer measurements is modified, a quantum error correction code is modified; and control operations for applying the modified quantum error correction code is modified accordingly. As shown in FIG. 3B, a first patch 330A, including a first stabilizer check qubit device 302A and associated data qubit devices 304, is for a X-type stabilizer measurement; a second patch 332A, including a second stabilizer check qubit device 302B and associated data qubit devices 304, is for a Z-type stabilizer measurement; a third patch 330B, including a third stabilizer check qubit device 302C and associated data qubit devices 304, is for a X-type stabilizer measurement; and a fourth patch 332B, including a fourth stabilizer check qubit device 302D and associated data qubit devices 304, is for a Z-type stabilizer measurement. When quantum error correction code is updated, the first patch 330A may be modified from the X-type stabilizer measurement to the Z-type stabilizer measurement. In some implementations, the out-of-plane coupling elements 324 for coupling the stabilizer check qubit device 302A of the first patch 330A with the stabilizer check qubit device 326A is activated; and the out-of-plane coupling elements 324 for coupling the stabilizer check qubit device 302D of the fourth patch 332B with the intermediate stabilizer check qubit device 326D is activated. The in-plane coupling element 328 between the intermediate stabilizer check qubit devices 326A, 326D is activated. In this case, the two stabilizer check qubit devices 302A, 302D in the patches 330A, 332B are coupled; and the two patches 330A, 332B can be merged for the same X-type or Z-type stabilizer measurement. At the same time, in-plane coupling elements 328 between the intermediate stabilizer check qubit devices 326A, 326B, and between the intermediate stabilizer check qubit devices 326D, 326C are deactivated.

FIG. 4A is a schematic diagram showing aspects of an example quantum error correction pattern 400 of a quantum error correction code. As shown in FIG. 4A, the example quantum error correction pattern 400 includes planar code patches defined on a 2D lattice of qubit devices of a quantum processing unit. For example, the quantum error correction codes can be surface codes depending on the physical/logical error. In certain examples, the quantum error correction codes can be other quantum error correction codes, including those with two-dimensional connectivity graphs, such as 2D color codes and 2D compass codes. Square tiles in FIG. 4A represent stabilizer measurements. For instance, square tiles 402 are planar code patches of rotated surface codes for the Z-type stabilizer measurement and square tiles 404 are patches of rotated surface codes for the X-type stabilizer measurement. Each patch includes four data qubit devices 406; and each patch represents a weight-four stabilizer measurement. In some instances, the example error correction pattern 400 may be an initial quantum error correction pattern, which can be modified later during the iterative process 500 in FIG. 5.

In some instances, the quantum error correction pattern 400 may be modified. In some instances, modifying the quantum error correction pattern 400 may include modifying one or more of the following: a weight of a certain type of stabilizer measurement (FIG. 4B), a location of a certain type of stabilizer measurement (FIG. 4C), a number of a certain type of stabilizer measurement (e.g., FIG. 4D), and other parameters of the quantum error correction pattern 400. In some instances, the quantum error correction pattern 400 may be modified in another manner.

In some implementations, the quantum processing unit on which the quantum error correction code is applied includes a superconducting quantum circuit. In some instances, the quantum processing unit can be implemented as the example superconducting quantum processing unit 204, 300, 320 as shown in FIGS. 2, 3A-3B or in another manner. Each square tile 402, 404 includes a stabilizer check qubit device at the center of a square tile communicably coupled to four data qubit devices at the vertices of the same tile. In certain examples, the stabilizer check qubit device and the data check qubit devices in a square tile may be implemented as the qubit devices 212, 302 of the superconducting quantum processing unit 204, 300, 320 in FIGS. 2, 3A-3B or in another manner.

As shown in FIG. 4A, performing stabilizer measurement operations by operation of stabilizer check qubit devices occur in patterns, for instance ZZZZ alternating with XXXX, when applying quantum error correction. The presence or absence of errors in the physical qubit devices associated with applying operations on the logical qubit (e.g., applying quantum logic gates or performing readout measurements) can be detected as a change in the stabilizer measurement sequence, for instance observing (a−1) stabilizer outcome when (a+1) outcome is anticipated. In some instances, a decoding algorithm can be executed by a decoder to determine what the most likely root-cause error is. In certain instances, corrective action, e.g., the application of quantum logic gates, or an update to the post-processing sequence, can be performed in response. Examples for performing quantum error correction are described in the publication entitled “Surface codes: Towards practical large-scale quantum computation” by Fowler et al. (Phys. Rev. A 86, 032324, 2012), in the publication entitled “Low-distance Surface Codes under Realistic Quantum Noise” by Tomita et al. (arXiv: 1404.3747v3 [quant-ph], Apr. 14, 2014), and in the publication entitled “Deep neural decoders for near term fault-tolerant experiments” by Chamberland et al. (arXiv: 1802.06441v2 [quant-ph], Feb. 18, 2018).

FIG. 4B is a schematic diagram showing aspects of an example quantum error correction pattern 420 of a quantum error correction code. In some implementations, the example quantum error correction pattern 420 is formed by modifying the example quantum error correction pattern 400 in FIG. 4A. As shown in FIG. 4B, the example quantum error correction pattern 420 includes planar code patches defined on a 2D lattice of qubit devices of a quantum processing unit. For example, the quantum error correction code can be surface codes depending on the physical/logical error. In certain examples, the quantum error correction code can be other quantum error correction code, including those with two-dimensional connectivity graphs, such as 2D color codes and 2D compass codes. Square tiles in FIG. 4B represent different stabilizer measurements. For instance, square tiles 402 are patches of rotated surface codes for Z-type stabilizer measurements; and square tiles 404 are patches of rotated surface codes for X-type stabilizer measurements.

In some implementations, the quantum processing unit on which the quantum error correction pattern 420 is applied includes a superconducting quantum circuit. In some instances, the quantum processing unit can be implemented as the example superconducting quantum processing unit 204, 300, 320 as shown in FIGS. 2, 3A-3B or in another manner. Each square tile includes a stabilizer check qubit device at the center of a square tile communicably coupled to four data qubit devices at the vertices of the same tile. In certain examples, the stabilizer check qubit device and the data check qubit devices in a square tile may be implemented as the qubit devices 212, 302, 304 of the superconducting quantum processing unit 204, 300, 320 in FIGS. 2, 3A-3B or in another manner.

As shown in FIG. 4B, the example quantum error correction pattern 460 is formed by modifying a weight of a type of stabilizer measurement relative to other stabilizer measurements, e.g., modifying a relative weight of stabilizer measurements. In particular, the example quantum error correction pattern 420 includes a first patch 422 for a Z-type stabilizer measurement and a second patch 424 for an X-type stabilizer measurement. The first patch 422 includes eight data qubit devices and three stabilizer check qubit devices; and the first patch 422 represents a weight-eight Z-type stabilizer measurement. The second patch 424 includes six qubit devices and two stabilizer check qubit devices; and the second patch 424 represents a weight-six X-type stabilizer measurement. Each of the first and second patches 422, 424 includes an expanded weight within the logical qubit, which alters the logical error. In some instances, the example quantum error correction pattern may be modified in another manner. A quantum error correction pattern may be selected through simulations on an emulator or evaluations on hardware. In some instances, the expansion of Z-type or X-type stabilizer measurement may be applied in different directions (e.g., X or Y direction), sizes, locations, or shapes. For example, the expanded patches of Z-type of X-type stabilizer check may include any number of data qubit devices. For another example, the updated quantum error correction pattern 420 may include multiple expanded patches of Z-type or X-type stabilizer measurements. In some implementations, the expansion of Z-type or X-type stabilizer measurements in a quantum error correction code is determined by noise type in the quantum circuit devices or algorithmic errors associated with applying a quantum computing program.

In some implementations, when an X-type or Z-type stabilizer measurement is performed in a patch of a quantum error correction code, a single X-type or Z-type measurement is performed over all the data qubit devices in the patch. For example, the eight data qubit devices in the first patch 422 are measured in a first single measurement; and the six data qubit devices in the second patch 424 are measured in a second, distinct single measurement. As shown in FIG. 4B, the second patch 424 is an immediate neighbor to two square patches 404 for the same X-type stabilizer measurements, the X-type stabilizer measurements in these three patches are performed during three different time steps by performing three separate single measurements.

FIG. 4C is a schematic diagram showing aspects of an example quantum error correction pattern 440 of a quantum error correction code. In some implementations, the example quantum error correction pattern 440 is formed by modifying the example quantum error correction pattern 400 in FIG. 4A. As shown in FIG. 4C, the example quantum error correction pattern 440 includes planar code patches defined on a 2D lattice of qubit devices of a quantum processing unit. Square tiles 402 are patches of rotated surface codes for Z-type stabilizer measurements; and square tiles 404 are patches of rotated surface codes for X-type stabilizer measurements. As shown in FIG. 4C, the example quantum error correction pattern 440 includes planar code patches defined on a 2D lattice of qubit devices of a quantum processing unit. As shown in FIG. 4C, the example quantum error correction pattern 440 is formed by modifying locations of different types of stabilizer measurements in the quantum error correction pattern 400 in FIG. 4A.

As shown in FIGS. 4A and 4C, the example quantum error correction patterns 400, 440 both include eight patches of X-type stabilizer measurements and eight patches of Z-type stabilizer measurements. Unlike the regular alternating error correction pattern 400 in FIG. 4A, the example quantum error correction pattern 440 in FIG. 4C is irregular. Unlike the error correction pattern 420 in FIG. 4B, the example quantum error correction pattern 440 in FIG. 4C does not include “merged” or “expanded” patches. In other words, all the patches in the example quantum error correction pattern 440 represent weight-four stabilizer measurements. In some implementations, a single measurement over all the four data qubit devices 406 within a single patch is performed. In some instances, the example quantum error correction pattern 440 may be configured in another manner, e.g., different locations of X-type or Z-type stabilizer measurements.

FIG. 4D is a schematic diagram showing aspects of an example quantum error correction pattern 460 of a quantum error correction code. In some implementations, the example quantum error correction pattern 460 is formed by modifying the example quantum error correction pattern 400 in FIG. 4A. As shown in FIG. 4D, the example quantum error correction pattern 460 includes planar code patches defined on a 2D lattice of qubit devices of a quantum processing unit. Square tiles 402 are patches of rotated surface codes for Z-type stabilizer measurements; and square tiles 404 are patches of rotated surface codes for X-type stabilizer measurements. As shown in FIG. 4D, the example quantum error correction pattern 460 is formed by increasing the number of patches of X-type stabilizer measurements and reducing the number of patches of Z-type stabilizer measurements. In particular, the quantum error correction pattern 460 includes ten patches of X-type stabilizer measurements and six patches of Z-type stabilizer measurements. In some instances, the quantum error correction pattern 460 may be configured in another manner. For example, the quantum error correction pattern 460 may include a different number of patches of X-type stabilizer measurement; and the patches for X-type or Z-type stabilizer measurement may be configured at different locations.

FIG. 5 is a flow diagram showing aspects of an example process 500. The example process 500 may be executed by components of systems of a computing environment. For example, operations of the example process 500 shown in FIG. 5 includes an application domain 502, a quantum circuit emulator domain 504, and a quantum computing domain 506. In some instances, the application domain 502 may include operations that are performed by operation of one or more classical computing system (e.g., the user device 110 of the example computing environment 100 in FIG. 1); and the quantum circuit emulator domain 504 may be include operations that are performed by operation of one or more classical computing system (e.g., the classical processors 111 of the server 108 of the example computing environment 100 in FIG. 1); and the quantum computing domain 506 may include operations that are performed by operation of the quantum computing system (e.g., the quantum computing system 103 in FIG. 1). The example process 500 may include additional or different operations, including operations performed by additional or different components or subsystems in the computing environment, and the operations may be performed in the order shown or in another order.

In some implementations, the example process 500 can be performed in a hybrid computing system including classical computing resources and quantum computing resources. The classical computing resources includes one or more classical computing systems; and the quantum computing resources includes a quantum computing system. The one or more classical computing systems are configured to perform operations in application domain 502 and the quantum circuit emulator domain 504. The quantum computing system for performing operations in the quantum computing domain 506 may be a quantum processing unit with qubit devices and other quantum circuit devices. The hybrid computing system further includes a noisy quantum circuit emulator for performing operations in the quantum circuit emulator domain 504 and configured to represent a hardware system. The hybrid computing system further includes a memory unit (e.g., the memory 112 of the server 108 in FIG. 1) for storing information including a description of the logical algorithm or target error processes.

In the application domain 502, the overall goal and structure for the quantum computation is defined. For example, a quantum computation task can be defined in a high-level programming language, generated with an application-specific library, or defined in some intermediate representation of a quantum computing program, including hybrid quantum-classical programs. Input data and other algorithm descriptions and constraints may be included, as well as any front-end support for interacting with the quantum computing system, including automated tasks, etc.

In the quantum circuit emulator domain 504, estimation of logical errors can be performed, by operation of a quantum circuit simulator. For example, a desired computation using nearest-Clifford group elements can be modeled, using Pauli noise models expected or extracted from the associated qubit devices. In the quantum circuit emulator domain 504, quantum error correction patterns of quantum error correction codes can be improved, optimized, or otherwise modified. In some instances, the quantum circuit emulator domain 504 includes classical computing resources that can be operated in parallel. For example, the quantum circuit emulator domain 504 may include one or more high-performance computers with hundreds or thousands of cores. In some instances, the classical computing resources for handling operations 516, 524, 526 within the quantum circuit emulator domain 504 can be communicably coupled with the quantum computing resources for performing operations in the quantum computing domain 506 through local-area network or high-speed interconnections (e.g., optical fibers) for minimized latency. Low-latency interconnections between the classical computing resources for performing operations within the quantum circuit emulator domain 504 and the quantum computing resources for performing operations within the quantum computing system domain 506 and the high processing speed of the classical computing resources within the quantum circuit emulator domain 504 are important to obtain fast time-to-solution. In the quantum circuit emulator domain 504, estimated logical errors for a multitude of hardware configurations are cached, or inference techniques (e.g., interpolation) are used to minimize calls to the emulator.

In the quantum computing system domain 506, the requisite application routines are executed and calibration of the qubit devices and other quantum circuit devices in a quantum processing unit are maintained by operation of quantum computing resources and associated software.

In some implementations, the example process 500 is used to update a quantum error correction code, for example, to modify a quantum error correction pattern as shown in FIGS. 4A-4B or in another manner. Operations in the example process 500 can be performed on a quantum processing unit with a physical layout shown in FIGS. 2, 3A-3B. The method and system presented here can be applied to quantum computing systems based on qubits/qudits and for updating a quantum error correction pattern.

At operation 512, a quantum computing routine is identified. In some implementations, the quantum computing routine can be defined by a compiler of a classical computing system based on a quantum computing program. For example, a compiler can be configured to compile and convert a user program into the quantum computing routine that can be executed by the quantum computing system. In some implementations, a quantum computing routine includes operations and patterns of operations compatible with the quantum circuit devices of the quantum computing system. In some instances, the compiler determines the quantum computing routine according to the quantum circuit devices of the quantum computing system used for performing the quantum computing routine. In some instances, a quantum computing routine may be a previously compiled/optimized quantum computing routine that is featured in quantum computing programs, for example a quantum Fourier transform instruction. In some implementations, when the quantum computing routine is identified, the target values of logical errors associated with the quantum computing routine can be defined. In some implementations, when the quantum computing routine is identified, target computations and configurations, as well as constraints and error tolerances (e.g., for estimating initial resources is operation 514) are also defined.

At operation 514, initial resources are estimated. In some implementations, the initial resources are estimated by the compiler of the classical computing system. In some implementations, the initial resources estimated during the operation 514 include quantum computing resources and classical computing resources for executing the quantum computing routine defined in operation 512. In some implementations, the compiler is further configured for estimating logical qubit count, types of quantum logic gates, and approximate scheduling with associated gate counts. In some instances, optimizations to minimize gate depth or other quantum circuit translations may be applied during operation 514 to determine the initial resources required for performing the quantum computing routine. In some implementations, an abstract desired logical qubit count, gate sets, instruction schedule on abstract representation, for instance patches of surface codes with associated initialization, lattice surgery, and measurements are determined during the operation 514; and are transferred to the classical computing systems; and used in performing operations 516 and 524 in the quantum circuit emulator domain 504. In some instances, other requirements can be obtained during operation 514 and can be transferred to subsequent operations in the same domain or different domains.

At operation 516, a quantum error correction code is initialized. In some implementations, an initial quantum error correction code defined by initial quantum error correction code parameters is selected and applied during execution of the quantum computing routine. In some implementations, an initial quantum error correction code that is compatible with the requirements received from the operation 514 is obtained. For example, a template surface code or a pre-determined surface code can be stored in a memory unit of the classical computing system and selected. In some instances, when a quantum error correction code is a template surface code, defining a quantum error correction code includes optimizing a quantum error correction pattern of patches of the surface code to have locality on a physical graph, or distance of patches to tune the logical error based on initial resource estimations determined during operation 514. This may include details of the available operations and physical fabric of the quantum processing unit, including schedule of physical operations to achieve the target logical algorithm. This may include error mitigation strategies or concatenation of multiple quantum error correction codes. In some instances, instructions for defining logical qubits and operations on the logical qubits (e.g., logical gate sets and associated control operations applied on the logical qubits) can be determined during operation 516. The instructions may include a subset of the full quantum computing routine as part of a quantum computing program.

At operation 518, physical errors on qubit devices associated with applying operations on a logical qubit are estimated. In some implementations, an estimation of the noise type and noise degree for the qubit devices is obtained, for example, using Randomized Benchmarking (RB), Cycle Benchmarking (CB), tomography, or another technique. In some implementations, the physical errors associated with the physical operations to define or manipulate logical qubits are analyzed. Calibrations may be optimized given a collection of target physical operations and knowledge about their deployment in a quantum program, for example, trading off errors in one physical operation for another. In some implementations, stabilizer measurement is performed, and outcomes of the stabilizer measurement are used for logical qubit decoding and associated meta-data.

At operation 520, a decoder is trained. In some implementations, a decoder is configured to process the outcomes of the stabilizer measurements from operation 518 into an associated error diagnosis. In some instances, a decoder may be part of a controller of the quantum computing system f (e.g., the controller 106A of the quantum computing system 103A in FIG. 1) or performing operations in the quantum computing domain 506. For example, a decoder can be trained by measuring the evolution of known logical qubit states or sequences of logical operations and using that data to populate a look-up table, to train a neural network, or to perform another process. In some instances, parameters of the decoder for different hardware configurations can be cached, or inference techniques (e.g., interpolation) can be used to minimize the requisite number of training events. In some instances, a decoder is trained or has valid training data for all or nearly all of the unique logical operations associated with the quantum computing routines of a quantum computing program. In some instances, a decoder is defined algorithmically (e.g., minimum weight perfect matching) or relies on proxies of hardware performance, such as gate error estimation, and does not require hardware-in-the-loop training. In some implementations, configurations of the decoder are determined.

In some implementations, when a quantum error correction code applied on a logical qubit is updated, the stabilizer measurements on the logical qubit are updated; and the outcomes of the stabilizer measurements are changed. In this case, the decoder is updated to process the outcomes of the updated stabilizer measurements. In some instances, the updated decoder can provide updated rules to interpret the outcomes from the updated stabilizer measurement and update operations on hardware to track the logical errors. The decoder can be used to determine error syndrome according to the outcomes from the update stabilizer measurement.

At operation 522, observed values of the logical errors associated with applying the operations on the logical qubits are measured by operation of the quantum computing system. In some implementations, the observed values of the logical errors associated with the logical qubits and configurations of quantum circuit devices defining the respective logical qubits are measured using Real Benchmarking, tomography, or performing other measurement techniques on the quantum computing system. In some instances, configuration of the hardware and the decoder, including device parameters of the qubit devices and gate parameters of the quantum logic gates are determined during operation 522; and can be further used when executing the quantum computing routine in operations 528. The manner of data encoding and decoding operations informs the effective algorithmic error associated with logical algorithms.

The abstract desired logical qubit count, gate sets, instruction schedule on abstract representation, for instance patches of surface codes with associated initialization, lattice surgery, and measurements can be determined during the operation 514 and transferred to and used in operation 524 of the quantum circuit emulator domain 504. In some implementations, after operation 514, the example process 500 continues with operation 524 in the quantum circuit emulator domain 504, during which a target value of the logical error associated with applying the operations on the logical qubit are obtained. In some implementations, a simulation and associated analysis (e.g., circuit-level noise modeling) is conducted to estimate the sensitivity of a quantum computing program to the logical errors. For example, biased X-type or Z-type errors may be different across different logical qubits. For example, a quantum processing unit which has dynamical coupling/decoupling properties (e.g., the quantum processing unit in FIGS. 2, 3A-3B), may be relatively more sensitive to X-type errors. In some implementations, target values of the logical errors associated with applying operations on the logical qubits are obtained during operation 524; and can be further used during operation 526 to determine an updated quantum error correction code. In some instances, a target value of the logical error associated with applying the operations on the logical qubit can be obtained in another manner, e.g., from an input of a user.

The threshold error (p_{TH}) of a quantum error correction code can inform an exponential relationship between the logical error (p_{L}) and physical error (p), for instance as p_{L}˜(p/p_{TH})^{d/2}, where d is the distance of the quantum error correction code. The threshold error p_{TH} depends on factors including: the choice error syndrome that the decoder uses to estimate the logical state, the types of errors (e.g., X-type or Z-type) associated with the hardware, and other factors. Improving the threshold error p_{TH} for a hardware platform is essential because doing so exponentially reduces the logical error p_{L} at a fixed code distance, or, for a fixed logical error p_{L}, an improvement in the threshold error p_{TH} lowers the requisite physical overhead. In some implementations, the threshold error p_{TH} can be improved by tailoring the quantum error correction code.

In some instances, construction of the stabilizer measurement in the quantum error correction code (e.g., a conventional surface code design leverages Calderbank-Shor-Steane (CSS) type stabilizers or a non-CSS stabilizer measurement) can affect the threshold error p_{TH} for biased noise. In certain instances, the amount of X-type stabilizer measurements versus Z-type stabilizer measurements in a quantum error correction code for a logical qubit may affect the threshold error p_{TH}. For example, a surface code design (e.g., a 2D compass code) having non-equal numbers of weight-4 X-type and Z-type stabilizer measurements in the error correction pattern can affect the threshold rate p_{TH} depending on the relative bias between the two types of errors.

After operations 522, 524, the example process 500 continues with operation 526, during which the quantum error correction code is updated. In some implementations, the quantum error correction code is updated based on the target values and the observed values of the logical errors obtained during operations 522, 524. In some implementations, updating a quantum error correction code includes changing a relative weight of one type of stabilizer measurements relative to another type for one or more of the logical qubits. For example, increasing the number of Z-type stabilizer measurements based on observing more Z-type errors than the target errors with remaining error margin on the X error channel. In some instances, the quantum error correction code is updated based on one or more other criteria, including speed, quality of solution, energy, cost, etc.

In some instances, updating the quantum error correction code includes updating one or more quantum error correction code parameters. For example, updating a quantum error correction code may include modifying (e.g., increasing or decreasing) a code distance of one or more logical qubits or a code distance of one or more associated operations applied on the logical qubits. Updating a quantum error correction code may include modifying relative dimensions of one or more logical qubits to trade-off Z-type or X-type errors. Updating a quantum error correction code may include multiple trial configurations to test on hardware. Updating a quantum error correction code may include analyzing information from previous configurations and benchmarking. Updating a quantum error correction code may include tuning dimensions of qubit devices over qudits to achieve higher noise bias. For example, a three-level qutrit definition of a transmon qubit device with one energy level (|1 [symbol] state) designated as an error state, is capable of detecting single-photon loss events and can be used as a “flag” in a decoding algorithm. In some implementations, updated instructions for defining updated logical qubits and operations on the updated logical qubits are determined during operation 526; and the updated instructions can be further sent to the quantum computing system for performing operations in the quantum computing domain 506, e.g., during operation 518.

In some instances, updating a quantum error correction code may be performed at runtime during the execution of the quantum computing routine when applying the quantum computing program. In some instances, an updated quantum error correction code with modified quantum error correction code parameters may be determined prior to applying the quantum computing routine. In some implementations, updating the quantum error correction code is based on an objective function, e.g., minimizing the difference between the target values and observed values of the logical errors, or according to other criteria. In some implementations, when a quantum error correction code is updated, the error correction code parameters which define the quantum error correction code are modified. In some implementations, updating the quantum error correction code during operation 526 includes performing an optimization process or another type of iterative process over the initial error correction code parameters based on the target values and the observed values of the logical errors. In some implementations, the modified quantum error correction code parameters are determined by the optimization or another type of iterative process.

As shown in FIG. 5, the example process 500 includes a first optimization loop which includes the iterative operations 526→518→520→522→526.

For example, before updating the quantum error correction code the quantum computing program including the quantum computing routine is executed by operation of the quantum computing system during operation 528. In some implementations, when the quantum computing program is executed, the initial quantum error correction code defined by the initial error correction code parameters is applied while executing the quantum computing routine. For example, an initial quantum error correction code may have equal numbers of Z-type and X-type stabilizer measurements as shown in FIG. 4A.

For example, physical error associated with updated physical operations according to the modified quantum error correction code can be estimated in operation 518; the decoder is updated according to the updated quantum error correction code in operation 520; and the logical errors associated with the updated configuration of the qubit devices and logical qubits are determined in operation 522. The first optimization loop is a closed loop optimization of logical qubits and operations given a target logical error model and a physical hardware platform. In some implementations, the iterative operations 518, 520, 522, 526 terminates once an optimized error correction configuration is obtained according to a predefined criterium; and the example process 500 continues with operation 528, where the application is executed. In some implementations, a runtime engine for executing the quantum logic circuits under the optimized error correction configuration. In some implementations, during operation 528, bitstring samples from the quantum processing unit, or post-processed results such as average values are obtained. In some implementations, results from executing the target routines during operation 528 includes meta-data about how the computation was performed, for instance parameters in a variational-type algorithm, or statistical information about the results. In some instances, the results from executing the application during operation 528 can be further used in operation 530 in the application domain 502. In some implementations, the one or more classical computer systems are configured to cause the quantum computing system to apply the quantum error correction code while executing the quantum computing routine during 528.

At operation 530, the application results are received, stored and further used during the operation 526 for executing future quantum computation tasks. During operation 530, the results from executing the quantum computing routine in the quantum computing domain 506 are received and analyzed by estimating the value of an objective function, gradient information of the objective function. Parameter or instruction updates are provided to the quantum computing program for further computation. Interfacing results to the front-end of the quantum computing system in the application domain 502 is also performed. In some implementations, during operation 530, updates to the quantum instructions to be performed, for instance new parameters that describe the angle of rotation for one or more unitary gate operations as part of a variational-type algorithm are obtained during operation 530 and can be further used by the operation 528 in the quantum computing domain 506. In some implementations, estimates for algorithmic errors based on execution engine, that may be used, for instance, to update the associated target logical errors or diagnose differences between the target and observed values of the logical errors according to the error correction code parameters of the quantum error correction code, can be obtained during operation 530; and can be further used during operation 526 in the quantum circuit emulator domain 504. In some implementations, the quantum error correction code is updated based on the target values of the logical errors, the observed values of the logical errors, and the observed values of the algorithmic errors.

As shown in FIG. 5, the example process 500 includes a second optimization loop which includes the iterative operations 526→532→534→536→538→516→526. The second optimization loop is a closed loop optimization of logical qubits and operations given an application-level objective function and a physical hardware platform.

Some of the operations described in this specification can be implemented as operations performed by a data processing apparatus on data stored on one or more computer-readable storage devices or received from other sources.

The term “data-processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

In a general aspect, a method of modifying a quantum error correction code for logical qubits is described.

In a first example, a method of a quantum error correction code for a quantum computing system includes, by operation of one or more classical computing systems, determining target values of logical errors associated with applying operations on logical qubits; by operation of the quantum computing system, measuring observed values of the logical errors associated with applying the operations on the logical qubits; and by operation of the one or more classical computing systems, updating the quantum error correction code based on the target values and the observed values of the logical errors. Updating the quantum error correction code includes modifying a quantum error correction pattern for one or more of the logical qubits. The method further includes, by operation of the quantum computing system, applying the quantum error correction code while executing a quantum computing routine. The quantum error correction code is applied using the modified quantum error correction pattern for the one or more of the logical qubits.

Implementations of the first example may include one or more of the following features. Modifying the quantum error correction pattern includes modifying a relative weight of stabilizer measurement. Updating the quantum error correction code includes performing an iterative process over an initial relative weight of stabilizer measurements for the one or more of the logical qubits based on the target values and the observed values of the logical errors. The modified relative weight of stabilizer measurements is determined by the iterative process. Updating the quantum error correction code includes modifying a code distance of one or more of the logical qubits or modifying a code distance of one or more of the operations on the logical qubits based on the target values and the observed values of the logical errors. Updating the quantum error correction code includes modifying the relative dimensions of one or more of the logical qubits based on the target values and the observed values of the logical errors. Updating the quantum error correction code includes tuning dimensions of physical qubit devices over qudits based on the target values and the observed values of the logical errors.

Implementations of the first example may include one or more of the following features. The quantum error correction code includes a plurality of planar code patches. The plurality of planar code patches includes X-type stabilizer patches and Z-type stabilizer patches. Modifying the quantum error correction pattern includes determining an updated value of a weight of the X-type stabilizer patches relative to the Z-type stabilizer patches. The quantum computing system includes a superconducting quantum processing unit including coupling elements between respective pairs of qubit devices. Applying the quantum error correction code includes operating a subset of the coupling elements. Each of the plurality of planar code patches includes a respective stabilizer check qubit. Applying the quantum error correction code includes activating a coupling element communicably coupled between a stabilizer check qubit in an X-type stabilizer patch and a stabilizer check qubit in a Z-type stabilizer patch.

Implementations of the first example may include one or more of the following features. The method includes, by operation of the quantum computing system, estimating physical errors on qubit devices associated with applying the operations on the logical qubits; and training a decoder based on the estimated physical errors. The quantum error correction code is applied using the modified quantum error correction pattern and the trained decoder. Estimating the physical errors includes performing stabilizer measurements; and updating the quantum error correction code includes updating the stabilizer measurements.

Implementations of the first example may include one or more of the following features. The quantum computing routine is component of a quantum computing program. The method includes before updating the quantum error correction code, executing the quantum computing program by operation of the quantum computing system. Executing the quantum computing program includes applying the quantum error correction code using an initial relative weight of stabilizer measurements while executing the quantum computing routine. The method further includes before updating the quantum error correction code, by operation of the one or more classical computing systems, determining observed values of algorithmic errors associated with the execution of the quantum computing program. The quantum error correction code is updated based on the target values of the logical errors, the observed values of the logical errors, and the observed values of the algorithmic errors.

Implementations of the first example may include one or more of the following features. The one or more classical computing systems includes an application domain that identifies the quantum computing routine based on the quantum computing program; and determines the observed values of the algorithmic errors; and a quantum emulator that: initializes the quantum error correction code; determines the target values of the logical errors; receives the observed values of the logical errors; and updates the quantum error correction code based on the target values and the observed values of the logical errors.

In a second example, a computing system includes one or more classical computing systems. The one or more classical computing system is configured to determine target values of logical errors associated with applying operations on logical qubits; receive, from a quantum computing system, observed values of the logical errors associated with applying the operations on the logical qubits; and update a quantum error correction code based on the target values and the observed values of the logical errors. Updating the quantum error correction code includes modifying a quantum error correction pattern for one or more of the logical qubits.

Implementations of the second example may include one or more of the following features. The computing system includes the quantum computing system. The quantum computing system is configured to measure the observed values of the logical errors associated with applying the operations on the logical qubit; and apply the quantum error correction code while executing a quantum computing routine. The quantum error correction code is applied using the modified relative weight of stabilizer measurements for the one or more logical qubits.

Implementations of the second example may include one or more of the following features. Modifying the quantum error correction pattern includes modifying a relative weight of stabilizer measurement. The one or more classical computing systems are configured to perform an iterative process over an initial relative weight of stabilizer measurements based on the target values and the observed values of the logical errors. The modified relative weight of stabilizer measurements is determined by the iterative process. The one or more classical computing systems are configured to modify a code distance of one or more of the logical qubits or modifying a code distance of one or more of the operations on the logical qubits based on the target values and the observed values of the logical errors. The one or more classical computing systems are configured to modify relative dimensions of one or more of the logical qubits based on the target values and the observed values of the logical errors. The one or more classical computing systems are configured to tune dimensions of physical qubit devices over qudits based on the target values and the observed values of the logical errors.

Implementations of the second example may include one or more of the following features. The quantum error correction code includes a plurality of planar code patches. The plurality of planar code patches includes X-type stabilizer patches and Z-type stabilizer patches. Modifying the quantum error correction pattern includes determining an updated value of a weight of the X-type stabilizer patches relative to the Z-type stabilizer patches. The quantum computing system includes a superconducting quantum processing unit which includes coupling elements between respective pairs of qubit devices. Applying the quantum error correction code includes operating a subset of the coupling elements. Each of the plurality of planar code patches includes a respective stabilizer check qubit, and applying the quantum error correction code includes activating a coupling element communicably coupled between a stabilizer check qubit in an X-type stabilizer patch and a stabilizer check qubit in a Z-type stabilizer patch.

Implementations of the second example may include one or more of the following features. The quantum computing system is configured to: estimate physical errors on qubit devices associated with applying the operations on the logical qubits; and train a decoder based on the estimated physical errors. The quantum error correction code is applied using the modified quantum error correction pattern and the trained decoder. The quantum computing system is configured to perform stabilizer measurements.

Implementations of the second example may include one or more of the following features. The quantum computing routine is component of a quantum computing program. The quantum computing system is configured to execute the quantum computing program by applying the quantum error correction code using an initial relative weight of stabilizer measurements while executing the quantum computing routine. The one or more classical computing systems are configured to determine observed values of algorithmic errors associated with the execution of the quantum computing program. The quantum error correction code is updated based on the target values of the logical errors, the observed values of the logical errors, and the observed values of the algorithmic errors.

Implementations of the second example may include one or more of the following features. The one or more classical computing systems includes an application domain that: identifies the quantum computing routine based on the quantum computing program; and determines the observed values of the algorithmic errors; and a quantum emulator that: initializes the quantum error correction code; determines the target values of the logical errors; receives the observed values of the logical errors; and updates the quantum error correction code based on the target values and the observed values of the logical errors.

In a third example, a computing system includes a quantum processing unit and a control system. The quantum processing unit includes a superconducting quantum processing circuit; and the superconducting quantum processing circuit includes data qubit devices, stabilizer check qubit devices, first coupling elements configured to communicably couple respective pairs of a data qubit device and a stabilizer check qubit device within the superconducting quantum processing circuit, and second coupling elements configured to communicably couple respective pairs of stabilizer check qubit devices within the superconducting quantum processing circuit. The control system is communicably coupled to the quantum processing unit. The control system is configured to cause the quantum processing unit to process the quantum information based on logical qubits. The operation of the quantum processing unit is based on a definition of the logical qubits on respective subsets of the data qubit devices and the stabilizer check qubit devices connected in an error correction pattern, an application of a quantum error correction code to the logical qubits, and an update to the quantum error correction code applied to the logical qubits by modifying a relative weight of stabilizer measurements for one or more of the logical qubits.

Implementations of the third example may include one or more of the following features. The data qubit devices and the stabilizer check qubit devices reside on a layer of a substrate, and the first and second coupling elements reside on the same layer. The stabilizer check qubit devices include a first subset and a second subset. The data qubit devices and the first subset of stabilizer check qubit devices reside on a first layer of a substrate; and the second subset of stabilizer check qubit devices reside on a second distinct layer.

Implementations of the third example may include one or more of the following features. The control system is configured to apply the quantum error correction code to the superconducting quantum processing circuit based on the error correction pattern, and to update the quantum error correction code by updating the error correction pattern. The quantum error correction code includes a compass code. Updating the quantum error correction code includes modifying a code distance of one or more of the logical qubits or modifying a code distance of one or more of the operations on the logical qubits, modifying relative dimensions of one or more of the logical qubits, or tuning dimensions of physical qubit devices over qudits.

Implementations of the third example may include one or more of the following features. Modifying the quantum error correction pattern for one or more of the logical qubits includes operating at least one second coupling elements. The control system includes one or more decoders associated with the quantum processing unit. The control system is further configured to update the one or more decoders according to the updated quantum error correction code. The application of the quantum error correction code includes operation of the one or more decoders to process error syndromes. The application of the quantum error correction code includes operation of the stabilizer check qubit devices to perform stabilizer measurements. Each of the second coupling elements includes at least one of capacitive, inductive, or galvanic circuit connections. Each of the first or second coupling elements includes a tunable-frequency coupler device.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple implementations separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made.

1. A method of modifying a quantum error correction code for a quantum computing system, the method comprising, by operation of one or more classical computing systems:
obtaining target values of logical errors associated with logical qubits of the quantum computing system;
obtaining observed values of the logical errors associated with applying the operations on the logical qubits;
updating the quantum error correction code based on the target values and the observed values of the logical errors, wherein updating the quantum error correction code comprises modifying a quantum error correction pattern for one or more of the logical qubits; and
causing the quantum computing system to apply the quantum error correction code while executing a quantum computing routine, wherein the quantum error correction code is applied using the modified quantum error correction pattern for the one or more of the logical qubits.

2. The method of claim 1, wherein modifying the quantum error correction pattern for the one or more of the logical qubits comprises modifying a relative weight of stabilizer measurements for the one or more of the logical qubits

3. The method of claim 2, wherein updating the quantum error correction code comprises performing an iterative process over an initial relative weight of stabilizer measurements for the one or more of the logical qubits based on the target values and the observed values of the logical errors, and the modified relative weight of stabilizer measurements is determined by the iterative process.

4. The method of claim 1, wherein updating the quantum error correction code comprises modifying a code distance of one or more of the logical qubits or modifying a code distance of one or more of the operations on the logical qubits based on the target values and the observed values of the logical errors.

5. The method of claim 1, wherein updating the quantum error correction code comprises modifying the relative dimensions of one or more of the logical qubits based on the target values and the observed values of the logical errors.

6. The method of claim 1, wherein updating the quantum error correction code comprises tuning dimensions of physical qubit devices over qudits based on the target values and the observed values of the logical errors.

7. The method of claim 1, wherein the quantum error correction code comprises a plurality of planar code patches, the plurality of planar code patches comprises X-type stabilizer patches and Z-type stabilizer patches, and modifying the quantum error correction pattern comprises determining an updated value of a weight of the X-type stabilizer patches relative to the Z-type stabilizer patches.

8. The method of claim 7, wherein the quantum computing system comprises a superconducting quantum processing unit comprising coupling elements between respective pairs of qubit devices, and applying the quantum error correction code comprises operating a subset of the coupling elements.

9. The method of claim 8, wherein each of the plurality of planar code patches comprises a respective stabilizer check qubit, and applying the quantum error correction code comprises activating a coupling element communicably coupled between a stabilizer check qubit in an X-type stabilizer patch and a stabilizer check qubit in a Z-type stabilizer patch.

10. The method of claim 1, comprising, by operation of the quantum computing system:
estimating physical errors on qubit devices associated with applying the operations on the logical qubits; and
training a decoder based on the estimated physical errors,
wherein the quantum error correction code is applied using the modified quantum error correction pattern and the trained decoder.

11. The method of claim 10, wherein estimating the physical errors comprises performing stabilizer measurements, and updating the quantum error correction code comprises updating the stabilizer measurements.

12. The method of claim 1, wherein the quantum computing routine is component of a quantum computing program, and the method comprises:
before updating the quantum error correction code, executing the quantum computing program by operation of the quantum computing system, wherein executing the quantum computing program comprises applying the quantum error correction code using an initial relative weight of stabilizer measurements while executing the quantum computing routine;
before updating the quantum error correction code, by operation of the one or more classical computing systems, determining observed values of algorithmic errors associated with the execution of the quantum computing program,
wherein the quantum error correction code is updated based on the target values of the logical errors, the observed values of the logical errors, and the observed values of the algorithmic errors.

13. The method of claim 12, wherein the one or more classical computing systems comprise:
an application domain that:
identifies the quantum computing routine based on the quantum computing program; and
determines the observed values of the algorithmic errors; and
a quantum emulator that:
initializes the quantum error correction code;
determines the target values of the logical errors;
receives the observed values of the logical errors; and
updates the quantum error correction code based on the target values and the observed values of the logical errors.

14. A computing system comprising:
one or more communication interfaces communicatively coupled to a quantum computing system;
a set of one or more classical processors; and
computer readable medium comprising one or more instructions that, when executed, cause the set of classical processors to:
determine target values of logical errors associated with applying operations on logical qubits;
receive, from the quantum computing system via the one or more communication interfaces, observed values of the logical errors associated with applying the operations on the logical qubits; and
update a quantum error correction code based on the target values and the observed values of the logical errors, wherein the instructions cause, when executed, the set of classical processors to update the quantum error correction code based on a modification of a quantum error correction pattern for one or more of the logical qubits.

15. The computing system of claim 14, wherein modifying the quantum error correction pattern for the one or more of the logical qubits comprises modifying a relative weight of stabilizer measurements for the one or more of the logical qubits.

16. The computing system of claim 14, comprising the quantum computing system configured to:
measure the observed values of the logical errors associated with applying the operations on the logical qubits, and
apply the quantum error correction code while executing a quantum computing routine, wherein the quantum error correction code is applied using the modified quantum error correction pattern for the one or more logical qubits.

17. The computing system of claim 15, wherein the one or more classical computing systems are configured to perform an iterative process over an initial relative weight of stabilizer measurements based on the target values and the observed values of the logical errors, and the modified relative weight of stabilizer measurements is determined by the iterative process.

18. The computing system of claim 14, wherein the one or more classical computing systems are configured to modify a code distance of one or more of the logical qubits or modify a code distance of one or more of the operations on the logical qubits based on the target values and the observed values of the logical errors.

19. The computing system of claim 14, wherein the one or more classical computing systems are configured to modify relative dimensions of one or more of the logical qubits based on the target values and the observed values of the logical errors.

20-42. (canceled)

43. A computing system comprising:
means for modifying a quantum error correction code for a quantum computing system, wherein modifying the quantum error correction code comprises:
determine target values of logical errors associated with applying operations on logical qubits;
receive, from the quantum computing system via the one or more communication interfaces, observed values of the logical errors associated with applying the operations on the logical qubits; and
update a quantum error correction code based on the target values and the observed values of the logical errors, wherein the instructions cause, when executed, the set of classical processors to update the quantum error correction code based on a modification of a quantum error correction pattern for one or more of the logical qubits.
